(19) United States
(12) Patent Application Publication
(10) Pub. No.: US 2017/0178078 A1
(43) Pub. Date: Jun. 22, 2017

(54) SYSTEM AND METHOD FOR MATCHING CANDIDATES AND EMPLOYERS

(71) Applicant: Scoutahead.com, LLC, Chicago, IL (US)

(72) Inventor: Raj FERNANDO, Chicago, IL (US)

(21) Appl. No.: 15/370,367

(22) Filed: Dec. 6, 2016

Related U.S. Application Data
(60) Provisional application No. 62/268,940, filed on Dec. 17, 2015.
(60) Provisional application No. 62/268,943, filed on Dec. 17, 2015.
(60) Provisional application No. 62/329,757, filed on Apr. 29, 2016.
(60) Provisional application No. 62/329,761, filed on Apr. 29, 2016.

(51) Int. Cl. G06Q 10/10

(52) U.S. Cl. CPC G06Q 10/1053; G06F 17/3053

(57) ABSTRACT

In an embodiment, a computer-implemented method is disclosed to match skilled professionals with employers based on peer evaluations. In an embodiment, the method comprises receiving general and job-specific ratings from a group of skilled peers, and generating a set of overall scores for each peer, based on factors including the ratings received from other peers, the overall score of those peers, and the rating confidence of the peers. These scores quantify each peer's general and job-specific skills and traits. The method may further comprise using these overall scores to match a skilled professional seeking new employment opportunities with employers seeking suitable candidates for positions they have available in the same or related jobs.

### BACKGROUND

Field

This field is generally related to employment recommendation systems, feedback systems, surveys, and peer evaluations.

Related Art

Current methods of receiving feedback from peers often yield results that are inaccurate. Negative feedback can hurt the feelings of the individual being evaluated or cause inter-personal issues with the evaluator. For this reason, evaluators often overrate their peers' skills. This inaccurate feedback may impede an individual's ability to develop her skills, such as professional or social skills. Compounding this problem, a professional's perception of her skills may differ from her peer's.

Current methods of soliciting feedback from friends, coworkers, employees, subordinates, and customers are inadequate. Systems and methods are needed to encourage those providing feedback with a means to do so with confidence and privacy, while at the same time ensuring that the right degree of importance is attributed to any particular feedback based on the contextual significance of the person providing it.

For example, recruiting agents are tasked with finding job candidates with a particular set of skills. To identify those individuals, recruiters typically rely on the résumés provided by job-seeking individuals, and the skill sets provided by those individuals. Job seekers may inflate their resume and skills. Thus, a disconnect often exists between the candidates that recruiters propose to employers and the candidates employers seek.

Systems and methods are needed to facilitate self-improvement for individuals and groups. Systems and methods are also needed to more efficiently match employment candidates with employers.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1A is a diagram that illustrates an environment for providing professional self and peer evaluation and employment recommendations according to an embodiment.

FIG. 1B is a diagram that illustrates an environment for providing evaluations to users within a common interest group according to an embodiment.

FIG. 2A is a flowchart that illustrates a method for receiving self and peer evaluation and employment recommendations according to an embodiment.

FIG. 2B is a flowchart that illustrates a method for receiving evaluations on personalized statements, according to an embodiment.

FIG. 3 is a flowchart that illustrates a method for receiving candidate recommendations for a position opening at an employer, according to an embodiment.

FIG. 4A is a flowchart that illustrates a method for calculating overall scores on one or more criteria for each member of a group of professional peers, according to an embodiment.

FIG. 4B is a flowchart that illustrates a method for calculating overall scores on one or more criteria for a group of professional peers, according to an embodiment.

FIG. 4C is a flowchart that illustrates a method for calculating a score for a common interest group, according to an embodiment.

FIG. 5A is a diagram that illustrates a system for providing peer evaluation and candidate recommendation according to an embodiment.

FIG. 5B is a diagram that illustrates a system for providing user evaluations in a common-interest group according to an embodiment.

FIGS. 6-20 are diagrams that illustrate views of a graphical user interface provided to professionals, students and companies according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

Embodiments facilitate peer evaluation by anonymizing and aggregating evaluations provided by an individual's evaluators. By aggregating the results of several different evaluations, the individual evaluatee may never see the reviews provided by any individual evaluator. In addition, a certain number of evaluations may be required before the aggregated results appear to the evaluatee. Requiring a threshold number of evaluations before presenting the aggregated numbers may prevent the evaluatee from identifying what the feedback is provided by each evaluator.

The evaluation techniques described herein have at least three applications. First, the aggregated evaluation generated through this process can be used to match jobs with job seekers. To match jobs with job seekers, embodiments may search for professionals with skills, as specified in their peer evaluations, that would fit requirements of job openings that employers specified. In this way, embodiments assist employers in finding qualified candidates.

Second, the evaluations generated as disclosed herein may also facilitate the evaluatee's personal or professional development. The evaluations could, for example, help the evaluatee identify areas in which others perceive her as needing improvement. The evaluatee could work on these areas to improve her skills, seeking training if necessary.

In both of the first two applications, the evaluations may be generated based on input from peers. Peers, as described herein, encompass not just individuals, but also organizations, such as universities, trade associations, or past employers.

In a third application, evaluations may be made by socially connected users, members of a group sharing a common interest, members of a group associated together by a common employer, a common landlord, a common group activity, a common interest, etc. The evaluations may be used by a group having a common interest to solicit input from members of the group. Organizations and groups can also use the evaluation features disclosed herein. In some embodiments, groups of individuals can gather feedback about group-specific ideas or actions. For example, a group of tenants in an apartment building may rate how they like their monthly social hour.

In different embodiments, the results of the evaluation may be available to all members of the group, to only the individual who constructed the evaluation, or to a person different from the individual who constructed the evaluation, such as someone in a managerial position. As with other applications, these group-specific evaluations may be aggregated and anonymized so that an individual viewing the result may be unable to discern input that the particular evaluatees provided. In this way, techniques disclosed herein may be useful in collecting survey information.

In embodiments, a user group (including e.g., a professional group or a common-interest group) may be created by a moderator. The moderator may invite one or more users to be members of the group. Additionally or alternatively, the moderator may select a group name, and/or a group description. In an embodiment, once the group name and description has been selected, it may not be changed thereafter. The moderator may create a set of statements (e.g., up to 10 questions) for the group members to rate. The rating may be for example on a 1 to 5 scale, or on a True/False basis. The moderator may give different levels of permission to different members of the group. These permissions of a user may, for instance, allow the member to view all of the questions provided by the moderator, or only a subset of them.

Additionally or alternatively, the permissions of a member may allow the member to view an overall rating provided by all members of the group, the ratings provided by the member herself, and/or an overall rating provided by other group members to a specific set of questions directed to the member. The overall ratings on a question directed to a group member may be provided in an aggregated and anonymized fashion. In an embodiment, the permissions are set such that the overall ratings on a question directed to a group member may only be viewed by that member. Additionally or alternatively, the permissions may be set such that the overall group ratings are viewable only by the moderator, or all members of the group.

In each application, the evaluators may answer questions. The questions may, for example, be in the form of a statement about an evaluatee, and the evaluator may be asked to indicate the degree to which the evaluator agrees with the statement. The statements may be generated by subject matter experts or be in the public domain, and may be selected based on the evaluatee's occupation and the tasks the evaluatee performs. Alternatively, the statements may be written by an individual constructing a survey for a common interest groups or by the evaluatee herself. A statement written by the evaluatee herself may be referred to herein as a personalized statement.

Embodiments may provide the evaluatee control over who may provide feedback on the evaluatee's personalized statements. Each set of personalized statements may be associated with different permissions, e.g., different set of users that could view and/or rate those statements.

The personalized statements can be evaluated by other users to assess the level of interest those personalized statements may generate for additional users. In this way, user-generated statements can be utilized in evaluating other users in the same or a similar group if they are deemed relevant and interesting by.

Once evaluators provide their input, the evaluators' responses are aggregated. To aggregate the evaluators' responses, a weighted average may be used. The weights may correspond to the respective evaluators' reputation, skills, or ranking in a profession or interest group. The weights may correspond to evaluator's confidence in evaluating the evaluatee on the statement, or how well the evaluator knows the evaluatee, as reported by the evaluator or evaluatee. The weights may vary depending on whether the evaluator is within a particular group (e.g., a company or an academic institution) such that evaluations from individuals within certain groups are weighted more heavily than others. For example, in an academic group including faculty members, staff and students, all members may be asked to rate the catering service used for departmental meetings. In this example, the faculty members may be given a higher weight than the staff and students when aggregating the provided ratings.

Each of these features is described in greater detail below with respect to the drawings.

An Evaluation-Recommendation System

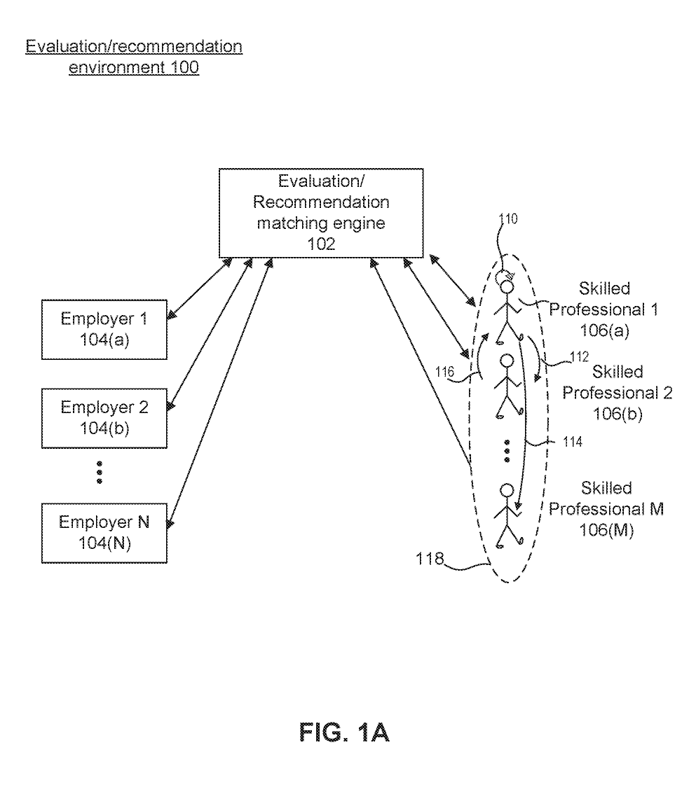

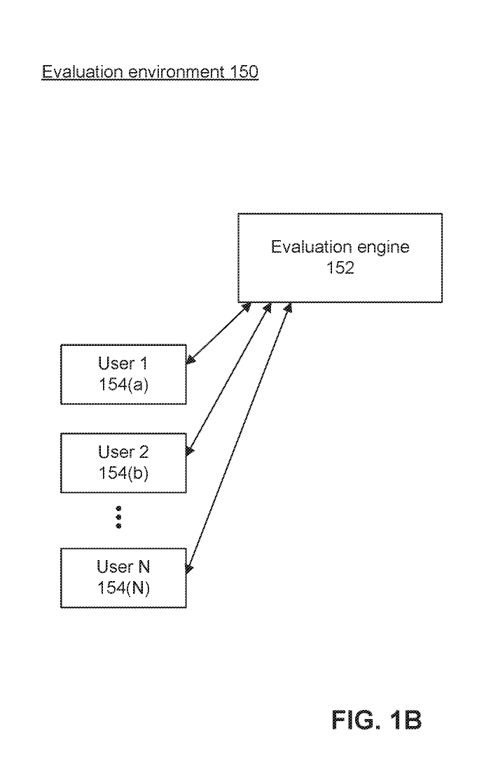

FIG. 1A is a diagram that illustrates an environment for providing professional evaluation and employment recommendations 100 according to an embodiment. Environment 100 comprises an evaluation/recommendation matching engine 102, one or more employers 104(a)-104(N), and one or more professionals 106(a)-106(M). Each of these components is described below.

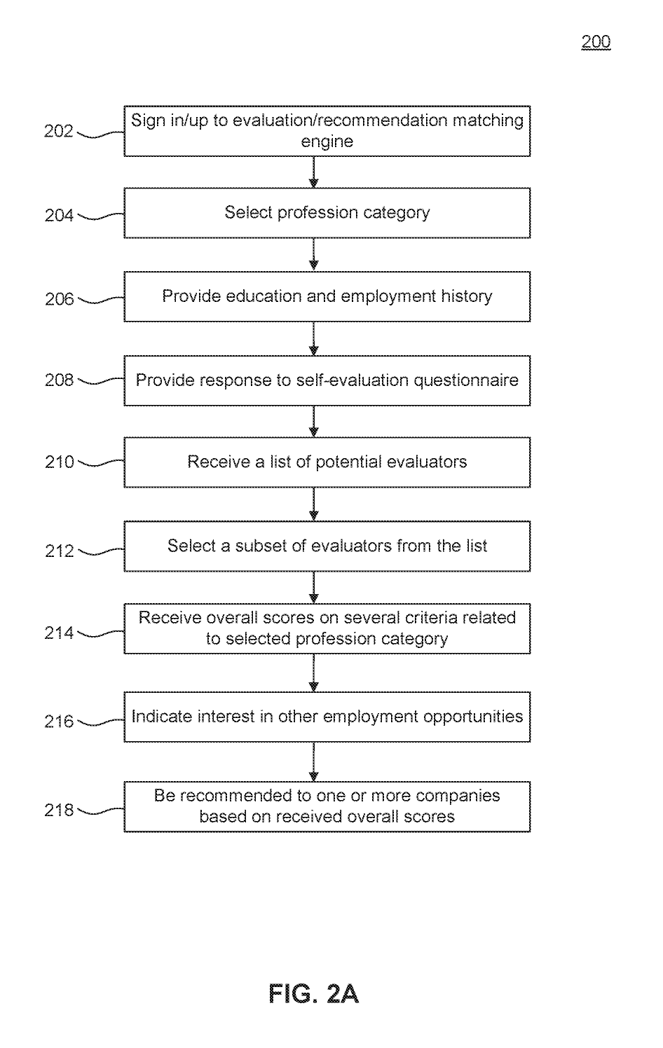

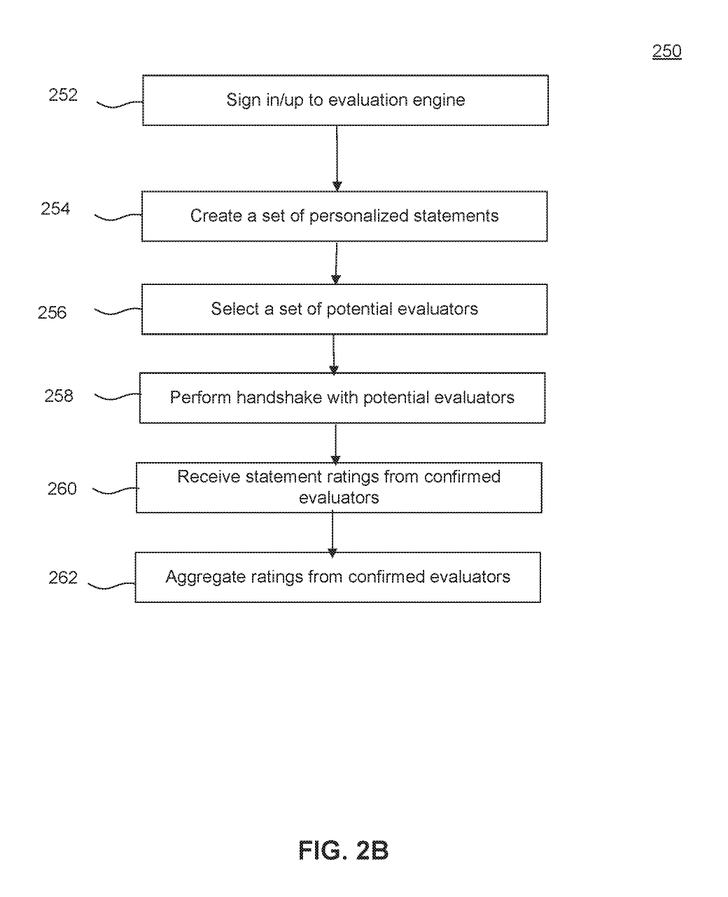

Evaluation/recommendation matching engine 102 comprises a set of users. The users may be of several types namely, professional individuals with expertise in a variety of areas, employers that are looking for good candidates to fill their open positions, and/or university students seeking to find their way to a job related to their training. Further details on the operation of the evaluation/recommendation matching engine 102 are provided below with respect to FIGS. 2A, 3, 4A-4B and 5A.

Employers 104(a) to 104(N), (collectively referred to as 104) are business enterprises (both for-profit and non-profit) such as technical companies, health care institutions, academic institutions, law firms, retailers, and manufacturers. These employers use the evaluation/recommendation matching engine 102 and seek recommendations for candidates to fill their open positions. Upon receiving the recommendations, the employers may perform further screening and/or interviews to ultimately select their desired candidates.

Professionals 106(a) to 106(M), (collectively referred to as 106) are individuals trained and/or hired in a position who have subscribed or registered with the evaluation/recommendation matching engine 102. These individuals may be, for example, students in their last year of training and looking to find their first job at entry level, or professionals previously and/or currently employed at a position and who may be interested in exploring new job opportunities.

Evaluation/recommendation matching engine 102 receives input from skilled professionals 106(a)-106(M) in form of ratings provided to a series of statements about their general traits and/or technical skills. These ratings are provided in a peer-based environment 118. These ratings may be provided by a professional her/himself, or by peer evaluators of the professional as will be described later with respect to FIG. 2A. In the example embodiment shown in FIG. 1, skilled professional 106(a) performs self-evaluation 110, and requests to be evaluated by professionals 106(b) and 106(M) by sending evaluation requests 112 and 114 respectively. Additionally, skilled professional 106(b) also sends an evaluation request 116 to skilled professional 106(a).

FIG. 1B is a diagram that illustrates an environment 150 for providing evaluations to users within a common interest group according to an embodiment. Environment 150 includes an evaluation engine 152, and one or more users 154(a) to 154(N). Each of these components is described below.

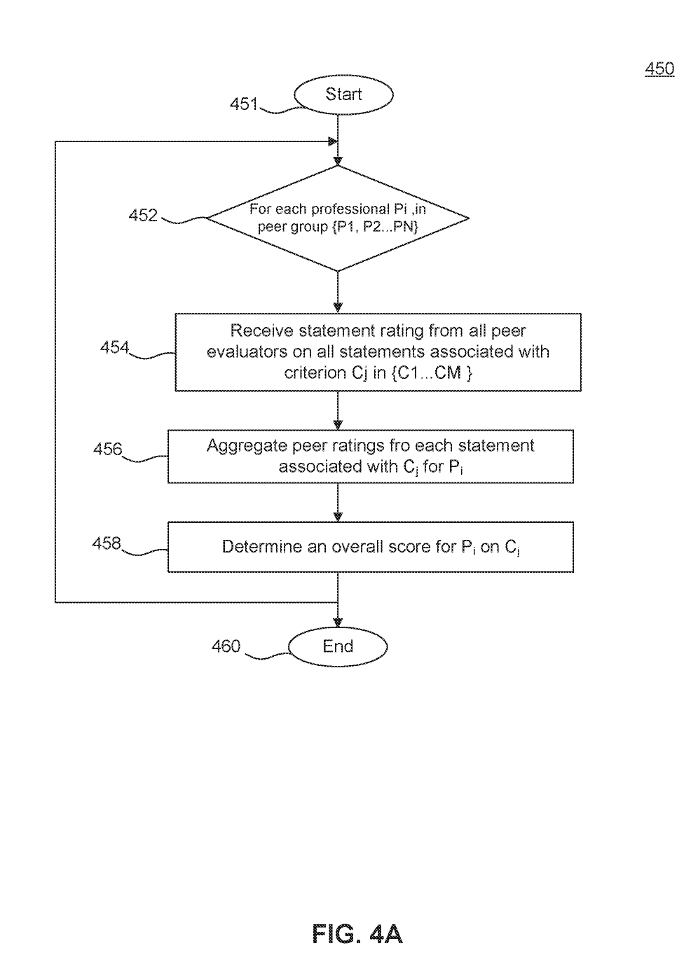

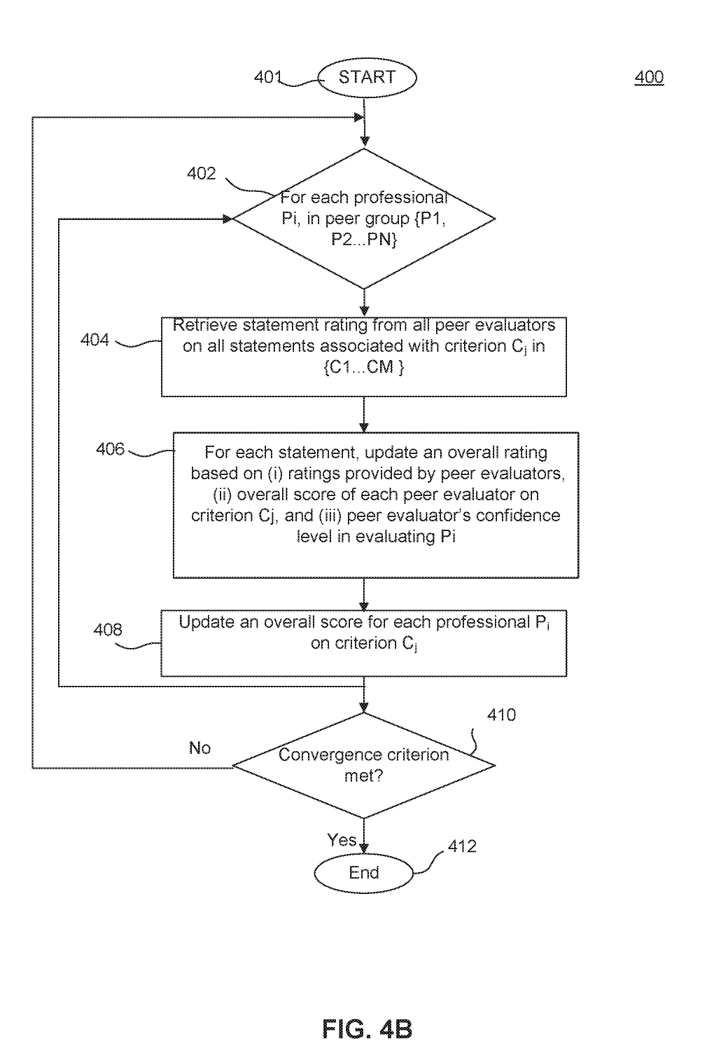

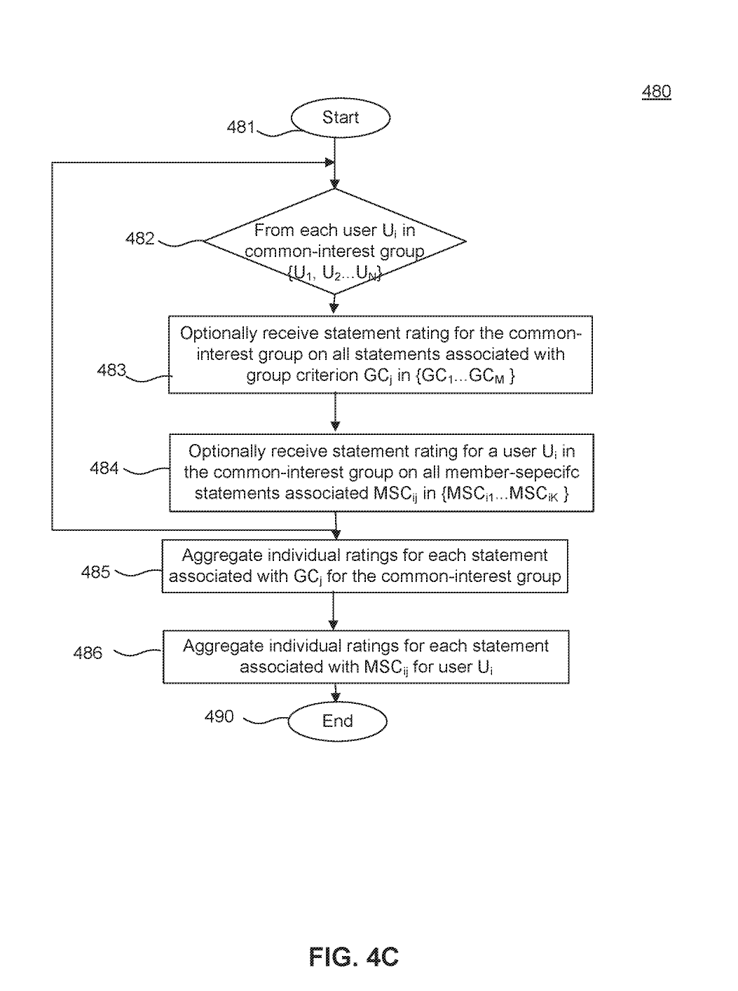

Evaluation engine 152 can have a set of users such as 154(a) to 154(N), collectively referred to as 154. The users may be of several types namely, professional individuals with expertise in a variety of areas, employees of a company, socially or professionally connected users, or a group of users sharing a common interest. Further details on the operation of the evaluation engine 152 are provided below with respect to FIGS. 2B and 4C.

FIG. 2A is a flowchart that illustrates a method 200 for receiving peer evaluation and employment recommendations according to an embodiment. Method 200 is a computer-implemented method, and may be implemented on one or more processors. Method 200 may be employed in operation of evaluation/recommendation matching engine 102 in FIG. 1A. In an embodiment, the one or more processors are also equipped with a graphical user interface. The graphical user interface may be used by a professional to perform the actions required by method 200, as described below.

Method 200 comprises step 202, where a professional, such as professional 106a, subscribes to an evaluation/recommendation matching engine, such as engine 102. The sign-up (subscription) process may, for example, entail creating authentication information, providing a profile picture, and/or providing a current résumé. The subscription may optionally entail providing account information for another public online platform such as Facebook, Google, etc., and may be used to link the user's profile with the other public platform. Such linking may be used to further verify the identity of the individual creating the profile. In an embodiment, a professional might elect to answer an initial set of survey questions in order to solicit feedback from the evaluation/recommendation matching engine before beginning step 202.

In an embodiment, the subscription may be performed once (in one session), where an account is created. In this embodiment, future logins (sessions) to the evaluation/recommendation matching engine may be performed (by providing authentication information such as username/password) to perform actions such as updating account and/or profile information, performing self-evaluation, accepting/rejecting peer evaluation requests, evaluating other peers, requesting evaluation from other peers, etc., as described below. Each of these and other actions may be performed in one session or multiple sessions.

Method 200 then proceeds to step 204, where the professional selects a profession category. The profession category may be based on her/his training and/or job experience. The profession category may have one or more subcategories, and may be organized in a tree-like structure. For example, a professional may first select “Engineering” as a category, and under this category select “software engineering” as a sub-category. Additionally, there may be one or more layers of sub-categories under “software engineering”, such as “application developer”, “system developer”, etc. The “application developer” sub-category may itself be further divided to subcategories such as “android developer”, “iOS developer”, and so forth. These profession categories may be generated, at least in part, using a third-party database or dataset.

In some embodiments, step 204 can also include a specific identification of tasks within a profession category that are most relevant to a particular professional. For example, if a professional is an attorney, he or she might see the wide variety of tasks that attorneys (broadly) do, but a particular attorney might only do certain of those tasks, such as writing wills but not doing criminal defense work. These tasks are the relevant “technical” or “job-specific” skills of a given professional. In some embodiments, step 204 may be repeated to include more than one profession, as well as the corresponding profession-specific tasks, if the professional has skills, interest or experience in more than one profession.

Method 200 then proceeds to step 206, where the professional provides her/his education and/or employment history. As will be described shortly, this history may be used to identify a set of peers that could evaluate the professional, and/or be evaluated by the professional.

Method 200 subsequently may proceed to step 208 where the professional provides ratings to a series of statements on his or her general traits and/or technical skills to conduct a self-evaluation. The statements may be selected based the profession and tasks selected in step 204.

In an example embodiment, experts in a profession identified through the evaluation/recommendation matching engine 202 may draft the statements describing the skills and traits relevant to that profession. The drafting may be done in a collaborative fashion with several experts participating in their development. The evaluation/recommendation matching engine 102 may select experts from among users that have received high overall scores based on the evaluations performed by their peers. For example, a software engineer with an overall rating of 5 out of 5 in all criteria related to his technical skills may be identified as an expert software engineer, and be contacted by the evaluation/recommendation matching engine 102 to provide statements describing the skills and traits that he deems valuable in evaluating a software engineer.

In an embodiment, a database of job-specific tasks and/or traits might be used where the tasks and/or traits are identified by experts outside of the evaluation/recommendation matching engine 202.

Notably, the steps in method 200 need not be performed in the order shown. For example, step 208 is performed before step 206. In another example, step 208 is fully or partially performed before step 202. For example, a user may rate a series of statements about her/his general traits (e.g., “risk taker”, etc.) to perform a self-evaluation before even signing up (subscribing) to the system. In this example, the user may be prompted to sign up after finishing the self-evaluation process, in order to request evaluation from her/his peers.

The statements may be directed at the professional's general traits may comprise, for example, “I am a risk taker”, “I avoid conflicts”, etc. The statements directed at the professional's technical skills may comprise, for example, “I am very comfortable with LINUX”, “I am very proficient at C++”, etc. During the self-evaluation, the professional may rate each of these statements from a pre-determined scale, e.g., 1-5, or 1-10. For example, the professional may assign a rate of “2 out of 5” to the statement “I am very comfortable with LINUX”, where 1 indicates “totally disagree” and 5 indicates “completely agree”. Other rating scales or interpretations may be used instead. Each statement may be associated with one or more criteria, as will be described in further detail shortly.

Method 200 then proceeds to step 210, where the professional receives a list of potential evaluators from the evaluation/recommendation matching engine if such potential evaluators are identified by the system. The evaluation/recommendation matching engine may generate this list based on the education and employment history of the professional. For example, if professional 106(a) has an employment overlap of a 4 years with another peer, e.g., professional 106(b), during which both peers worked for company A, and it is also indicated that both the professional 106(a) and his peer 106(b) were working in the same group within company A, then professional 106(b) is determined to be a good potential evaluator for professional 106(a). Based on such a mutual relationship between 106(a) and 106(b), the inverse would also be true. That is, professional 106(a) would also be determined as a good potential evaluator for professional 106(b).

Additionally or alternatively, the professional may suggest one or more evaluators. For example, professional 106(a) may suggest (and send an evaluation request to) professional 106(c) based on a professional cooperation during a project that both 106(a) and 106(c) worked on in college. Professional 106(a) may also invite a potential evaluator that is not a current user of the recommendation/evaluation/system to become a user so that both professional 106(a) and the potential evaluator can evaluate one another.

Method 200 then proceeds to step 212, where the professional selects a subset of potential evaluators provided in the list. In an example, the selection entails confirming the subset of potential evaluators via a graphical user interface.

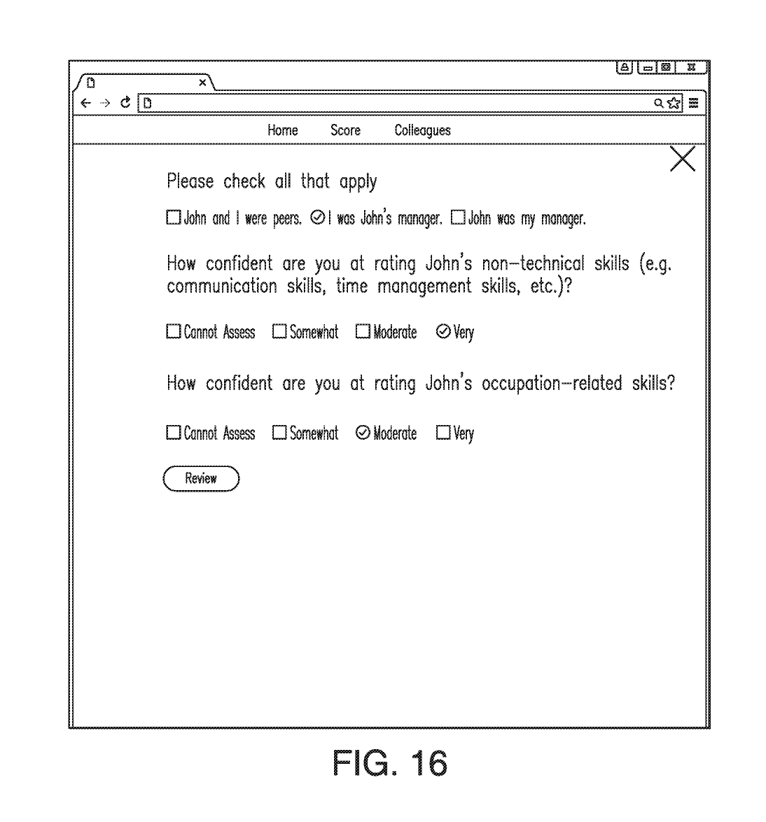

After selecting an evaluator, the professional will provide information about how the professional knows the potential evaluator to indicate the strength of the professional and the evaluator's relationship or experience with the professional. For example, the professional may select a score indicating a degree to which the professional believes the potential evaluator is familiar with her/his work. For example, the professional may enter information describing her relationship with the evaluator into a form similar to the one illustrated in FIG. 16.

After the professionals select evaluators and enter information describing their relationship, the selected potential evaluators may receive a request to perform evaluation for the professional. Each of the selected potential evaluators may accept or deny the request. If they accept the request, the potential evaluator will also have to identify the strength of his or her relationship with the requesting professional. In this fashion, there is a handshake between peer evaluators and evaluatees to facilitate accurate weighting of their evaluations of the other. The potential evaluators may also be asked to score the degree she is familiar with the professional's work. That score may be compared with the score entered by the professional. If those two scores not sufficiently similar, the evaluators input may be discounted.

In some embodiments, evaluators may proceed with providing evaluations without having been first requested by the evaluatee. In those embodiments, an evaluator submits its evaluation and describes how it know the evalutee, and the evaluation provided is stored by the evaluation/recommendation matching engine without being included in the evaluatee's aggregate evaluations. Once the evaluatee, however, verifies its relationship with the evaluator and states a desire for the evaluator's evaluation, then the evaluation shall be incorporated as if the evaluatee had specifically requested an evaluation from the evaluator.

The evaluators may be presented with statements similar to the statements that the professional responded to in her self-evaluation. The statements presented to the evaluators may be selected based on the professional's profession, the evaluator's profession, and the relationship between the evaluator and the professional. The relationship between evaluator in the professional may, for example, include whether they are peers, whether one is subordinate to the other, or the degree to which they claim to know each other. As will be described below with respect to FIG. 2B, the statements can also be written by the professional herself.

After responding to the statements, the responses are received at evaluation/recommendation matching engine 102. Once a threshold number of responses are received, the responses to various statements may be aggregated into overall scores for a category. Those aggregated responses may be included in a composite peer evaluation. As is discussed below, in one or more embodiments peer evaluations may be provided in a way that systematically anonymizes and aggregates them before providing information derived from those peer evaluations to a professional.

Method 200 subsequently proceeds to step 214, where the professional receives an aggregate evaluation based on peer and/or self-evaluation(s) including overall scores on one or more criteria. A criterion on which the professional receives an overall score may be general, e.g., “risk taker”, or specific to the profession category selected in step 204, e.g., “comfortable with variant operating systems”. The overall score the professional receives on each criterion is computed on the evaluation/recommendation matching engine.

The overall score computed for a specific criterion is based on a group of statements that are related to the criterion. In an example, criterion “comfortable with variant operating systems” is associated with three statements of “I am very comfortable with LINUX”, “I am very comfortable with iOS”, and “I am very comfortable with Windows”. If the professional receives an aggregate rating of 4 on “I am very comfortable with LINUX”, an aggregate rating of 4.1 on “I am very comfortable with iOS”, and an aggregate of 4.9 on “I am very comfortable with Windows”, then the overall score of the professional on the criterion (“comfortable with variant operating systems”) may be calculated as 4.67 (i.e., the average of the 3 ratings.). Note that one statement may be associated with more than one criterion. For example, the statement “I am very comfortable with LINUX” may also be associated with criterion “generally knowledgeable in computer programming”.

The overall score computed for each criterion is also based on the aggregation of ratings the professional received from the peer evaluators selected in step 212 and who also accepted to perform the evaluation. In an embodiment, overall scores based on aggregating peer evaluations may be separately received from overall scores that are derived from self-evaluations.

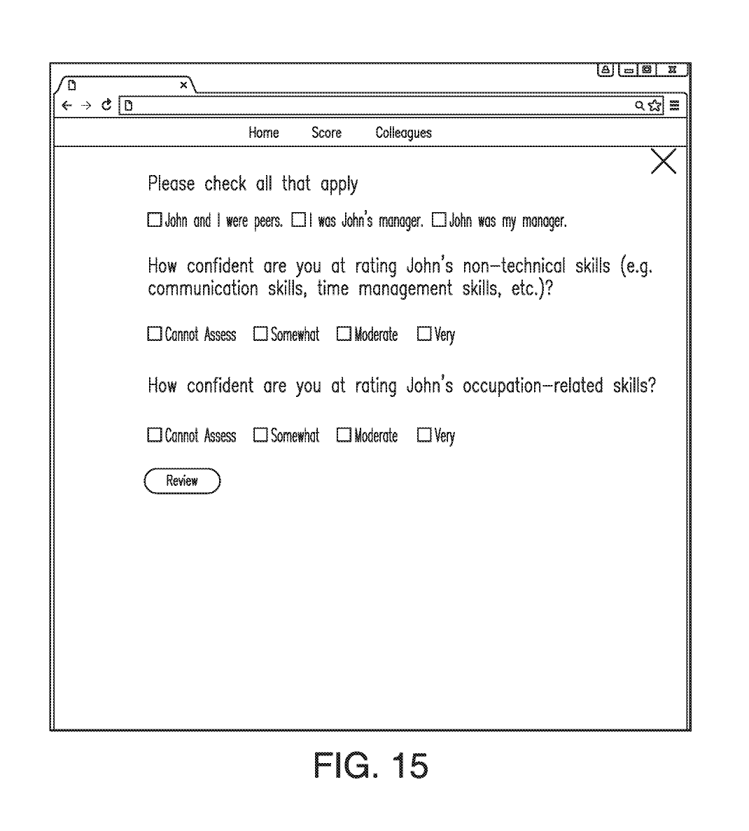

According to an embodiment, the peer evaluators may not be weighted equally in aggregating the ratings they provide on a statement. Peer evaluators that indicate a higher confidence in the ratings they provide in evaluating the professional receive higher weights when aggregating their provided ratings with the ratings provided by other peer evaluators. FIG. 15 illustrates an example where a peer evaluator may determine their confidence level in evaluating a peer.

Additionally or alternatively, when aggregating ratings from different peer evaluators on a specific statement, peer evaluators that themselves have higher overall scores on a criterion associated with the specific statement may be assigned higher weights. For example, a software developer professional that is him/herself deemed (by his/her peers) an “expert” in working with a variety of operating systems is in a better position to rate his peers on their skills in working with a variety of operating systems than is a junior software developer that recently graduated from college. Note that, in this manner, the ratings provided by evaluators not familiar with the professional's technical area may be given weight in evaluating the professional on his/her general traits such as “team player”, “risk taker”. However, the rating these evaluators provide on technical statements will have a negligible (if not zero) weight. Peer rating aggregation will be described in further detail with respect to FIGS. 4A and 4B.

Still considering FIG. 2A, in an embodiment, the professional is not able to see results of peer evaluations until a certain number of peer evaluations have been submitted. The peer evaluations may be anonymous, so that the professional does not know what specific peers said about the professional. Anonymization could occur, for example, by ensuring that a user's overall score is only calculated upon receiving a threshold number of new reviews. Ensuring that a certain number of peer evaluations have been submitted before an aggregate peer evaluation is available helps maintain anonymity of the peer evaluators. This anonymity allows for the peer evaluators to provide more honest ratings. In this embodiment, the only person that can see the overall scores the professional received in any criterion is him/herself. In this way, the evaluations are anonymous, and scores the professional receives remain confidential.

In an embodiment, after performing step 214, the professional may be shown the overall scores on one or more criteria based on peer evaluation, in contrast with the overall scores on the same one or more criteria based on self-evaluation. For example, these two sets of overall scores may be shown on a single display (e.g., side by side) of a graphical user interface. The professional may compare and contrast the two sets of scores to re-evaluate his/her strengths and weaknesses for self-improvement.

Still considering FIG. 2A, method 200 proceeds to step 216, where the professional indicates that he/she is interested in other employment opportunities related to his education and/or work experience.

If the professional is interested in seeking new employment, Method 200 then proceeds to step 218, where the professional is matched with one or more positions open at one or more employers, e.g. employer 104. The professional may be notified of such a match prior to being recommended to a potential employer. In an alternative embodiment, the professional is recommended directly to a potential employer and notified of an employer's interest. In either scenario, a potential employer (e.g., employer 104(a)), is provided with a professional's contact information and resume information, such as a resume document, work-history information, education-history information, and user-identified skills. For example, the professional's contact information and current résumé may be forwarded to employer 104(a), who may, upon further screening and/or interview, decide to hire the professional.

While FIG. 2A is discussed with respect to professional peers, a skilled artisan would recognize that the techniques employed in steps 210-214 may be used to solicit an evaluation from a group of individuals, such as a group having a common interest. The evaluation may be for an individual's performance, the group's performance, or other issue of interest to the group members. The statements for the evaluation may be specified evaluation may be aggregated and anonymized as described above, and may be presented to the entire group, a group leader, or any other individual.

FIG. 2B is a flowchart that illustrates a method 250 for receiving evaluations on personalized statements, according to an embodiment.

In step 252, a user, such as user 154(a), subscribes to an evaluation engine, such as 152. The subscription process in step 252 may occur as described above in step 202.

In step 254, the user creates a set of personalized statements. These personalized statements may be statements that the user has written and/or selected from a pool of statements available on the evaluation engine. A user may be able to edit their personalized statements several times. Additionally or alternatively, a user may be able to create more than one set of personalized statements. Each set of personalized statements may be limited to a maximum number of statements, e.g., five statements. Each set of personalized statements may be associated with different permissions, e.g., different set of users that could view and/or rate those statements.

In step 256, the user selects a set of potential evaluators to request anonymized feedback from on the created personalized statements. The user may, for example, identify specific individuals to provide feedback on the personalized statements. Alternatively, the user may indicate specific groups of individuals (like those who attended college with the user) to provide feedback.

In step 258, a handshake is performed between the evaluatee and selected evaluators. For example, the users selected as evaluators may need to first accept the request before they can view the personalized questions, before they can evaluate the personalized statements of the evaluate, and/or before their evaluations are taken into account when computing overall ratings as will be described shortly.

In an embodiment, an individual user desiring to be evaluated (evaluatee) may not need to specifically request certain users to provide ratings to his/her personalized statements. Instead, as the evaluatee makes connections with new users, the personalized statements of the evaluatee may be automatically sent to the newly connected users. The evaluatee may select whether to allow all, or just specific set of evaluators to view the evaluatee's personalized statements.

In step 260, the ratings from confirmed evaluators (those who successfully completed the handshaking of step 258) are received, for example, by the evaluation engine.

In step 262, the evaluation engine aggregates the ratings provided by each evaluator for every statement in the list of personalized statements. The aggregation may be based on averaging all the ratings directly or giving different weights to different evaluators. The weights may be based on several factors such as the level of confidence the evaluator has in rating the evaluatee on a statement or vice versa, and/or specific weights adjusted by the evaluatee.

The overall ratings from the aggregating of all ratings may be provided to the evaluate in an aggregated and anonymized fashion. That is, the evaluatee may not be able to see how each specific evaluators rated him/her on a statement.

In embodiments, the evaluatee has control in deciding which evaluators' evaluation provided for the personalized statements he/she likes to include in the overall aggregated and anonymized feedback provided to the evaluatee.

Since some evaluators may frequently change their ratings, in an embodiment, a snapshot is taken periodically (e.g., once a day, once a week, or once a month) from the overall ratings provided on a user's personalized statements and stored in the evaluation engine.

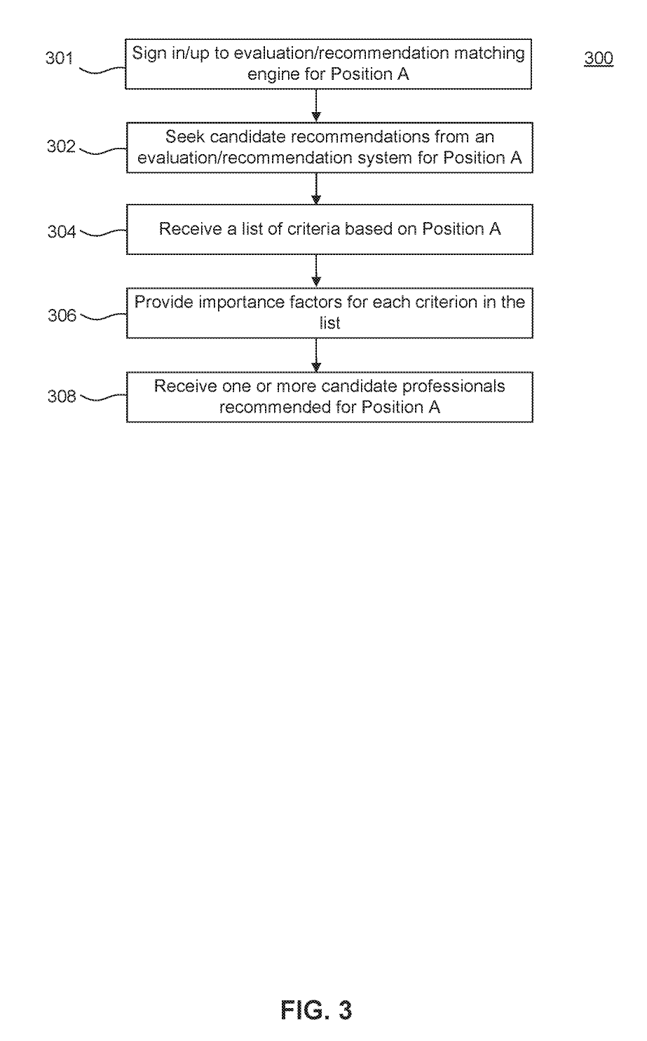

FIG. 3 is a flowchart that illustrates a method 300 for receiving candidate recommendations for a position opening at an employer, according to an embodiment. Method 300 is a computer-implemented method and may be implemented on one or more processors. In an embodiment, the one or more processors are also equipped with a graphical user interface. The graphical user interface may be used by an employer to perform the actions required by method 300, as described below.

Method 300 starts with an employer, such as employer 104(a), subscribing with the evaluation/recommendation matching engine 102. The subscription may entail, for example, creating authentication information, as well as providing a description of its business.

In an embodiment, the subscription may be performed once (in one session), where an account is created. In this embodiment, future logins (sessions) to the evaluation/recommendation matching engine may be performed (by providing authentication information such as username/password) to perform actions such as updating account and/or profile information, adding/removing open positions, soliciting recommendations for one or more open positions, etc., as described below. Each of these and other actions may be performed in one session or multiple sessions.

Method 300 then moves to step 302, where the employer indicates that it solicits recommendations from the evaluation/recommendation matching engine for candidates for its open position A.

Method 300 then moves to step 304, where the employer receives a list of criteria (and/or statements associated with the criteria) “relevant” to position A, where the relevance is from the perspective of the evaluation/recommendation matching engine. For example, if position A is a software development position, the employer may receive criteria such as “comfortable with variant operating systems”, or “experienced in multi-threaded environments”. Additionally, the employer may also receive general-trait criteria such as “risk taker”, “team player”, “gives clear direction to subordinates”, etc. In an embodiment, the employer provides a set of criteria, and a set of statements associated with each provided criterion. For example, the employer may be asked to provide at least two criteria each associated with 12 statements, and receive two criteria from evaluation/matching engine 102. In an embodiment, the employer may utilize evaluation/recommendation matching engine 102 for internal promotions or recruiting. For example, the employer may receive a criteria asking whether the employer wishes to be informed of candidates already employed by the employer.

Method 300 then proceeds to step 306 where the employer provides importance factors to each of the criteria (or statements associated with the criteria), based on what he deems important for a professional working in position A. For example, if position A is a junior software development position, the employer may assign an importance factor of zero to the “gives clear direction to subordinates” criterion, while assigning a higher importance factor to a criterion such as “follows instructions”. An employer may also input as criteria jobs requirements such as geographic location, prior work experience, degrees, certifications, or other educational requirements for any candidates for position A. In an embodiment where an employer seeks to promote an employee, an employer may choose to input as a criteria that the candidate is already employed by the employer.

Method 300 then proceeds to step 308 where the employer receives one or more recommended candidates that the evaluation/recommendation matching engine has determined most fit to function in position A. The candidates may be selected by searching the available candidates and determining which have the highest score in the different criteria the employer selected. In addition to the scores, the candidates may also be selected according to confidence values generated for the scores.

When several criteria are selected, a match index indicating the degree to which a professional is a good candidate for the position may be generated. The match index may be generated, for example, as a weighted average of the scores for the different criteria, the confidence values in the scores, and the relative importance the employers assigned to the different criteria. In step 308, the recommended candidates provided to the employer may be the professionals with the highest weighted average.

In addition, the recommended candidates provided in step 308 may be selected only from among those professionals that have indicated that they are interested in a position or in the type of position offered by the employer.

In an embodiment, the evaluation/recommendation matching engine identifies the candidates for position A by selecting among all professionals that are subscribed with it and meet several conditions. These conditions may comprise, for example, having indicated looking for a new position (as previously described with respect to step 216 of FIG. 2A), having indicated a profession category (as previously described with respect to step 204 of FIG. 2A) relevant to position A, etc. Additionally, among all those professionals that meet these conditions, the evaluation/recommendation matching engine may identify one (or more) professionals whose “match index” is the highest. The match index is a quantity indicative of the fit between the professional and position A. For example, the match index for professional 106(d) (who meets the conditions associated with position A) may be calculated by multiplying the overall score of professional 106(d) in each of the criteria received in step 304, with the respective importance factors of those criteria provided in step 306, and summing over all these weighted overall scores. In this manner, the evaluation/recommendation matching engine may identify the professional with the highest match index as a candidate for position A. Alternatively, the evaluation/recommendation matching engine may identify a few professionals with the highest match index (e.g., 5 professionals with the top 5 match indices) as candidates for position A.

The employer may take further actions based on the recommendations received in step 308. For example, the employer may perform phone screening and/or on-site interviews with one or more of the recommended candidates. In an embodiment, the employer does not receive any ratings, scores, etc., from the recommended (or any other) candidates. Instead, only non-confidential information such as the candidates' résumés, contact information, etc. is shared with the employer.

Overall Score Computation for Evaluatees

FIG. 4A is a flowchart that illustrates a computer-implemented method 450 for calculating overall scores on one or more criteria for each member of a group of professional peers (also referred to as peer group), according to an embodiment. A professional may be a member of more than one peer group. Members of a peer group do not need to know one another.

Method 450 starts at 451 and proceeds to step 452, where an operation loop is started for a peer group {P₁, P₂ . . . P_{N}} comprising professional peers, some of which evaluate some others.

The peers in the peer group may, for example, form a connected graph. That is, if a peer P₁ is represented by a node, and peer P₂ evaluates or is evaluated by peer P₁, the two nodes P₁ and P₂ are connected by a link. Representing the members of the peer group in this fashion would result in a connected graph, i.e., there is a path between every two nodes on the graph. In an embodiment, if a peer is not reviewed by at least 3 other peers, the peer is not qualified to be a member of the peer group.

In an embodiment, the operations performed in steps 452-458 are repeated for all peers in the peer group, and for all criteria in a set of criteria, e.g., criterion set {C₁, C₂ . . . C_{M}}. As described before with respect to FIG. 2A (e.g., step 214), each criterion may be associated with one or more statements. Also, as previously described with respect to FIG. 2A, the peers receive overall scores on each of these criteria.

In an embodiment, the operations performed in steps 452-458 are repeated for all peers in the peer group, but each peer may be evaluated on a different set of criteria. For example, some peers may be only evaluated on a subset of criteria selected from criterion set {C₁, C₂ . . . C_{M}}. However, the set of criteria used to evaluate each of the peers in peer group {P₁, P₂ . . . P_{N}} may not be mutually exclusive, i.e., have overlap.

The method proceeds to step 454 where, for each peer, such as Pᵢ, and for each criterion, such as Cⱼ, statement ratings are received for all statements associated with Cⱼ, from all peers that have previously agreed to evaluate Pᵢ (and were also approved as evaluators by Pᵢ).

In an embodiment, peer evaluators of a peer Pᵢ may be a subset of peers from peer group {P₁, P₂ . . . P_{N}}. That is, not each peer reviews every other peer in the peer group.

In an embodiment, one or more peers in the peer group may be tagged as special peers. These peers may be evaluated by all other members of the peer group. For example, a peer group may include engineers and interns. In this peer group, the interns do not evaluate the engineers, while each engineer evaluates all other engineers and all of the interns in the peer group.

The method subsequently proceeds to step 456 where, for each peer Pᵢ, for each criterion Cⱼ, and for each statement associated with Cⱼ, the ratings provided for the statement from the peer evaluators of Pᵢ are aggregated. For example, if Pᵢ has 4 peer evaluators, that have evaluated Pᵢ on criterion Cⱼ, and criterion Cⱼ is associated with 4 statements, then the overall score of Pᵢ on criterion Cⱼ is an aggregation of 16 ratings.

The aggregation across multiple peer evaluators may be a simple averaging operation. In that case, the overall rating for the statement is the average of all ratings provided by the peer evaluators of Pᵢ.

Alternatively, in an embodiment, the aggregation across multiple peer evaluators may be a weighted average, where the weights given to all peer evaluators of Pᵢ are not equal.

In an embodiment, the weight given to the peer evaluators of Pᵢ to determine the overall rating on a statement, e.g., statement S₁, associated with criterion Cⱼ may be based on (e.g., directly proportional to) a confidence level each of the peer evaluators of Pᵢ has determined in evaluating Pᵢ. For example, a peer evaluator of Pᵢ that has been his/her manager for 5 years may determine a confidence level of 4 (in a scale of 1 to 5, with 5 indicating most confident), while another peer evaluator of Pᵢ that was in the same company as Pᵢ for two years, but worked only occasionally with Pᵢ, may determine a confidence level of 2 (in the same 1-5 scale).

In an embodiment, a peer evaluator of Pᵢ may assign a confidence level at the granularity level of per-criterion, or even per-statement. Moreover, a criterion may consist of a single statement.

As previously mentioned, steps 452-458 are repeated for all professionals in the peer group, and for all criteria in the criterion set.

Once the loop for all professionals in the peer group, and for all criteria in the criterion set are completed, the method terminates in step 460.

FIG. 4B is a flowchart that illustrates a computer-implemented method 400 for calculating overall scores on one or more criteria for each member of a group of professional peers (also referred to as peer group), according to an embodiment.

Method 400 starts at step 402. At step 402, an operation loop is started. The loop repeats steps 404, 406, and 408 for each professional peer in a peer group {P₁, P₂ . . . P_{N}}, members of which evaluate each other.

In an embodiment, the operations performed in steps 402-408 are repeated for all peers in the peer group, but each peer may be evaluated on a different set of criteria. As described above, some peers may be only evaluated on a subset of criteria selected from criterion set {C₁, C₂ . . . C_{M}}.

As described above, the peers in the peer group may form a connected graph. That is, if a peer P₁ is represented by a node, and peer P₂ evaluates or is evaluated by peer P₁, the two nodes P₁ and P₂ are connected by a link. Representing the members of the peer group in this fashion would result in a connected graph, i.e., there is a path between every two nodes on the graph. In an embodiment, if a peer is not reviewed by at least 3 other peers, the peer is not qualified to be a member of the peer group.

At step 404, peer evaluations of professional Pᵢ are received. As described above, the peer evaluations can include a plurality of ratings on different statements, and the peer evaluations may be received from a plurality of professional Pᵢ's peers. Again as described above for step 214, the various statements can each be associated with a criterion from criteria set {C₁, C₂ . . . C_{M}}. Also, as previously described with respect to FIG. 2A, the peers receive overall scores on each of these criteria. At step 404, the peer evaluations may be received as new evaluations generated by peers, or the peer evaluations may simply be retrieved from memory. In one embodiment, the peer evaluations may be retrieved from persistent memory once and may be stored in the same location in transitory memory through the remainder of method 400.

In an embodiment, peer evaluators of a peer Pᵢ may be a subset of peers from peer group {P₁, P₂ . . . P_{N}}. That is, not each peer reviews every other peer in the peer group.

In an embodiment, one or more peers in the peer group may be tagged as special peers. These peers may be evaluated by all other members of the peer group. For example, a peer group may include engineers and interns. In this peer group, the interns do not evaluate the engineers, while each engineer evaluates all other engineers and all of the interns in the peer group.

Then, at step 406, for each statement, the statement ratings received at step 404 are aggregated. For example, if Pᵢ has 3 peer evaluators that have evaluated Pᵢ on criterion Cⱼ, and criterion Cⱼ is associated with 5 statements, then the overall score of Pᵢ on criterion Cⱼ is an aggregation of 15 ratings.

The aggregation across multiple peer evaluators may be a simple averaging operation. In that case, the overall rating for the statement is the average of all ratings provided by the peer evaluators of Pᵢ. Alternatively, in an embodiment, the aggregation across multiple peer evaluators may be a weighted average, where the weights given to all peer evaluators of Pᵢ are not equal.

In an embodiment, the weight given to the peer evaluators of Pᵢ to determine the overall rating on a statement, e.g., statement S₁, associated with criterion Cⱼ may be based on (e.g., directly proportional to) a confidence level each of the peer evaluators of Pᵢ has determined in evaluating Pᵢ. For example, a peer evaluator of Pᵢ that has been his/her manager for 5 years may determine a confidence level of 4 (in a scale of 1 to 5, with 5 indicating most confident), while another peer evaluator of Pᵢ that was in the same company as Pᵢ for two years, but worked only occasionally with Pᵢ, may determine a confidence level of 2 (in the same 1-5 scale).

In an embodiment, a peer evaluator of Pᵢi may assign a confidence level at the granularity level of per-criterion, or even per-statement.

In an embodiment, the weight given to the ratings of each of the peer evaluators of Pᵢ to determine the overall rating on statement S₁ associated with criterion Cⱼ may also be, for example, determined based on (e.g., directly proportional to) each respective peer evaluator's own overall score on criterion Cⱼ (or on statement S₁, associated with Cⱼ) or a closely-related criterion Cₖ, as will be described with respect to step 408 next. In this embodiment, the process for determining the overall rating for statement S₁, is iterative, as will be described below. In the first iteration of operating step 406, the aggregation of ratings from different peer evaluators of Pᵢ that evaluated him/her on statement S₁, may be a simple average, or a weighted average of all the ratings. For the aggregation based on weighted average, the weights may be selected based on the confidence level of the peer evaluators of Pᵢ in rating (evaluating) Pᵢ. Additionally or alternatively, the weights may be selected based on a reputation level of each peer evaluator of Pᵢ. For example, the peer group may consist of a group of medical specialists such as internists, radiologist, pathologists, etc. A high evaluation provided by a famous internist for a radiologist may be given a high weight.

In an embodiment, the confidence level, and therefore the weight of, a peer evaluator of Pᵢ may vary based on the criterion Cⱼ it is evaluating Pᵢ in, and/or based on the statement associated with Cⱼ on which it is evaluating Pᵢ.

The method then proceeds to step 408. At step 408 for each criterion Cⱼ, an overall score is determined based on all the ratings provided by the peer evaluators of Pᵢ on all the statements associated with Cⱼ. For example, if Pᵢ has been evaluated on criterion Cⱼ that has 5 statements, then the overall score of Pᵢ on criterion Cⱼ is an aggregation of 5 ratings. The overall score may be obtained by simply averaging over the overall rating for all statements (as previously described with respect to step 406) associated with Cⱼ. Alternatively, the overall score may be obtained by taking a weighted average of the overall rating for all the statements associated with Cⱼ, if some of the statements within Cⱼ are deemed more important than others.

As previously mentioned, steps 402-408 are repeated for all professionals in the peer group, and for all criteria in the criterion set.

Once the loop over all the peers in the peer group and all the criteria in the criterion set is completed, the method proceeds to step 410. At 410, a convergence test is performed to determine if the overall change in scores of the peers compared to the previous iteration is below a threshold. This determination may be made, for example, by taking the Euclidean distance between a first and second vector, where the first vector comprises one element per each criterion, whose value is the overall score of Pᵢ in that criterion at iteration k (the current iteration) and the second vector is similarly arranged except for reflecting overall scores corresponding to iteration k-1 (the previous iteration). This can be done by determining the difference between Pᵢ's overall score at iteration k (current iteration), and Pᵢ's overall score at iteration k-1 (previous iteration), calculating its square value (or other functions such as absolute value), and summing it over all peers.

The above quantity may then be compared to a threshold value ε, to determine convergence. That is, if the above quantity is smaller than ε, convergence has been reached and the method ends in step 412. Otherwise, the method proceeds to the next iteration at step 406.

In the next iteration (iteration k+1), while performing step 406, the overall scores calculated in iteration k are used in aggregating overall rates for all statements within each criterion Cⱼ for evaluating peer Pᵢ. This was previously described with respect to step 406.

In an embodiment, step 410 also comprises a check on the number of iterations performed so far. For example, there may be a pre-determined maximum count that once reached, results in the method to be terminated in step 412.

Method 400 may be triggered for a peer group in response to any changes that would result in a change in the ratings of one of the peers within the peer group. This may happen, for example, when one peer evaluator of peer Pᵢ modifies his evaluation, or when a new peer joins the peer group and provides evaluations on his/her peers, etc.

FIG. 4C is a flowchart that illustrates a computer-implemented method 480 for calculating overall scores on one or more criteria for a common-interest group of people (also referred to as an interest group comprising individual users with a common interest (e.g., employer, team, business division, families, friends) according to an embodiment.

In an example according to this embodiment, the common-interest group consists of all members of a volleyball team, and their coach. All of these group members are requested to evaluate their team's overall performance in different positions such as offense, service, defense, etc. In another example, the common-interest group consists of residents of an apartment building.

A common-interest group may be created by a moderator. The moderator may invite one or more users to be members of the common-interest group. Additionally or alternatively, the moderator may select a group name, a group description, and control user permissions, including which users can join the group. The moderator may create a set of statements (e.g., up to 10 questions) for the group members to rate. The rating may be, for example, on a 1 to 5 scale, or on a True/False basis.

In an embodiment, the moderator may give different levels of permission to different members of the common-interest group. In an embodiment, once permission settings on the statements have been set by the moderator, they cannot be changed thereafter.

The permissions can control which members can see which subset of the statements. Additionally, these permissions control if and how a member can see the results of an evaluation on a statement. For instance, the permissions may be set to allow a member to view all of the questions provided by the moderator, or only a subset of them. Additionally or alternatively, the permission settings may be such that they allow a member to view an overall rating provided by all members of the common-interest group for a question directed to the common-interest group, and/or the ratings provided by the member herself. The overall ratings may be provided to the members in an aggregated and anonymized fashion, so that no member can see how another member rated a question directed to the common-interest group. Additionally, a summary of the ratings provided by the members may be viewed by some or all members of the common-interest group. For example, statistics on the number of members who rated a statement at different levels, e.g., level 1, 2, . . . 5 in a 1-5 scale, or evaluated a statement as True or False, may be provided to some or all members of the common-interest group.

Additionally or alternatively, the permission settings may be such that an overall rating provided by other group members to a specific set of member-specific questions can only be viewed by the member to whom the questions are directed. The overall ratings on a question directed to the member may be provided to the member in an aggregated and anonymized fashion, so that the member cannot see how a particular other member has rated them.

In an embodiment, the permissions may be set such that the overall ratings on a member-specific question directed may also be viewed by the moderator or a specific member of the common-interest group. In this embodiment, the moderator or the specific member of the common-interest group may view the overall ratings of a member-specific statement in an aggregated and anonymous fashion. Alternatively, the moderator or the specific member of the common-interest group may view the individual ratings provided by other members for a member-specific statement.

Additionally or alternatively, the permissions may be set such that the overall group ratings on a member-specific question are viewable only by the moderator of the common-interest group. For example, in a common-interest group including students enrolled in a course and a professor that teaches the course, the students may be asked to evaluate the course in statements related to the material being taught, the teaching method, and the helpfulness of the professor. In this example, the professor may be the only one allowed to see the overall ratings of the statements.

Method 480 starts at step 481 and proceeds to step 482, where a loop is started for a common interest group {U₁, U₂ . . . U_{N}} comprising individual users related by a common interest. In the loop, steps 482, 483 and 484 may be repeated for each user Uᵢ in the common-interest group. At step 483, each user, such as Uᵢ, may optionally provide statement ratings for each criteria in a set of group criteria {GC₁, GC₂ . . . GC_{M}}. As described above with respect to FIG. 2A (e.g., step 214), each criterion may be associated with one or more statements. The common-interest group receives overall scores on each of these criteria.

At step 484, each user, such as Pᵢ, may optionally provide statement ratings for each criterion in a set of member-specific criteria. A member specific criterion may be related to one or more specific users Uᵢ. For example, user Uᵢ may be associated with a set of criteria {MSCᵢ₁, MSCᵢ₂ . . . MSC_{iM}}.

After receiving input from respective peers in the common-interest group, method 480 proceeds to steps 485 and 486. In step 485, for each group criterion GCⱼ, and for each statement associated with GCⱼ, the ratings provided for the statement are aggregated to determine an overall rating for the group on each group criterion GCⱼ. The ratings provided for each statement may be aggregated to determine an aggregated statement score, and the aggregated statement scores may be further aggregated to determine a score for each criterion GCⱼ. For example, if the common-interest group has four members that provided evaluation for the common-interest group on criterion GCⱼ, and criterion GCⱼ is associated with 4 statements, then the overall score of the common-interest group on criterion Cⱼ is an aggregation of 16 ratings.

The aggregation across multiple evaluators may be a simple averaging operation. In that case, the overall rating for the statement is the average of all ratings provided by the evaluators of the common-interest group.

Alternatively, in an embodiment, the aggregation across multiple evaluators may be a weighted average, where the weights given to all evaluators of the common-interest group are not equal. In an embodiment, the weights may correspond to a level of confidence in the evaluator. For example, the weights may be determined as described above with respect to FIG. 4B. In embodiment, the weights may be set by the creator or moderator of the common-interest group.

At step 486, for each user Uᵢ and for each member-specific criterion, MSCᵢⱼ, the ratings provided for the statement are aggregated to determine an overall rating for user Uᵢ on member-specific criterion, MSCᵢⱼ. The ratings provided for each statement may be aggregated to determine an aggregated statement score, and the aggregated statement scores may be further aggregated to determine a score for each criterion MSCᵢⱼ. For example, if user Uᵢ has two members that provided evaluation on criterion MSCᵢⱼ, and criterion MSCᵢⱼ is associated with three statements, then the overall score of user Uᵢ on criterion MSCᵢⱼ is an aggregation of 6 ratings.

As previously mentioned, steps 482-484 are repeated for all users in the common-interest group.

In an embodiment, the overall scores of the common-interest group may be viewed by all members of the group. Additionally or alternatively, in an embodiment, the overall score of the group may be viewed by others at managerial or administrative positions. In an example according to this embodiment, a sales manager managing several sales teams can use these scores to identify stronger or weaker sales teams. In an embodiment, the overall scores of the common-interest group may be viewed only by a moderator of the group.

In an embodiment, the overall scores of a group member on one or more member-specific criteria can be only seen be the group member in an aggregative and anonymized manner. That is, the group member cannot see how each other user in the common-interest group has rated them. Additionally or alternatively, the overall scores of the group member on one or more member-specific criteria may be viewed by a moderator of the group.

System Architecture

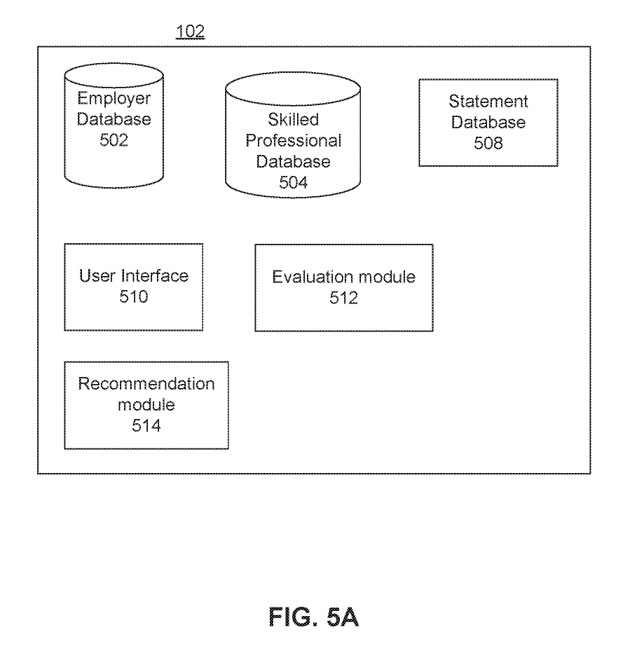

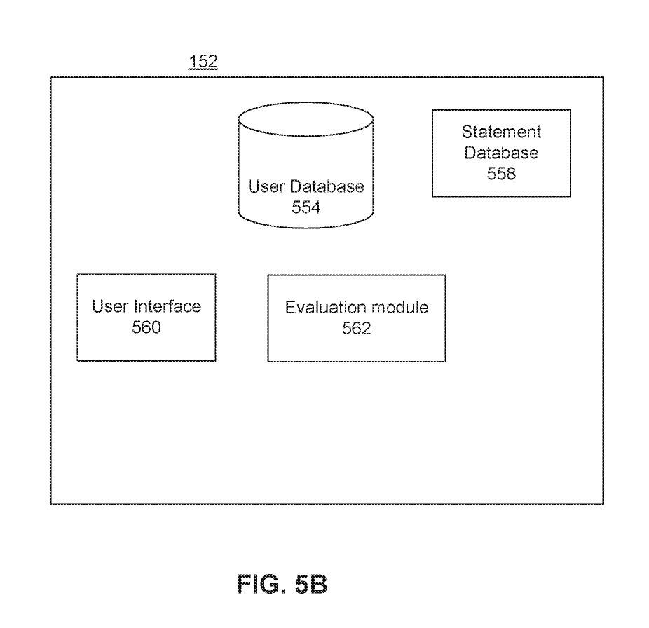

FIG. 5A is a diagram that illustrates a system for providing peer evaluation and candidate recommendation according to an embodiment.

Specifically, example components of the evaluation/recommendation matching engine 102 are depicted in FIG. 5A, according to an embodiment.

The evaluation/recommendation matching engine 102 comprises an employer database 502 that stores and maintains a list of all employers that subscribed with the system to receive candidate recommendations, as previously described with respect to FIGS. 1A and 3.

The evaluation/recommendation matching engine 102 further comprises a skilled professional database 504 that stores and maintains a list of all professionals, and/or students, that have subscribed with the system, their profession categories, and their education/employment history, as previously described with respect to FIGS. 1A and 2A.

The evaluation/recommendation matching engine 102 further comprises a statement database 506 that maintains and stores the list of all statements related to a variety of profession categories. In an embodiment, these statements may be maintained in tree-like data structures, where two profession categories with no overlap would be stored in two disjoint trees.

The evaluation/recommendation matching engine 102 further comprises a user interface 510 that facilitates receiving inputs from, and providing outputs to the users of the system. In an embodiment, the user interface is a web-based graphical user interface, and can be accessed via any of the common web browsers, such as Internet Explorer, Firefox, Safari, Chrome, etc. In another embodiment, the user interface is a software application that runs on a device such as a laptop, a smart phone or a tablet.

The user interface may provide different views to its different customers, i.e., a first view for employers, and a second view for professionals. Optionally, a third view may be provided to students, and/or a fourth view provided to those using only a subset of the evaluation functions such as members of a team or employees enrolled by their employer.

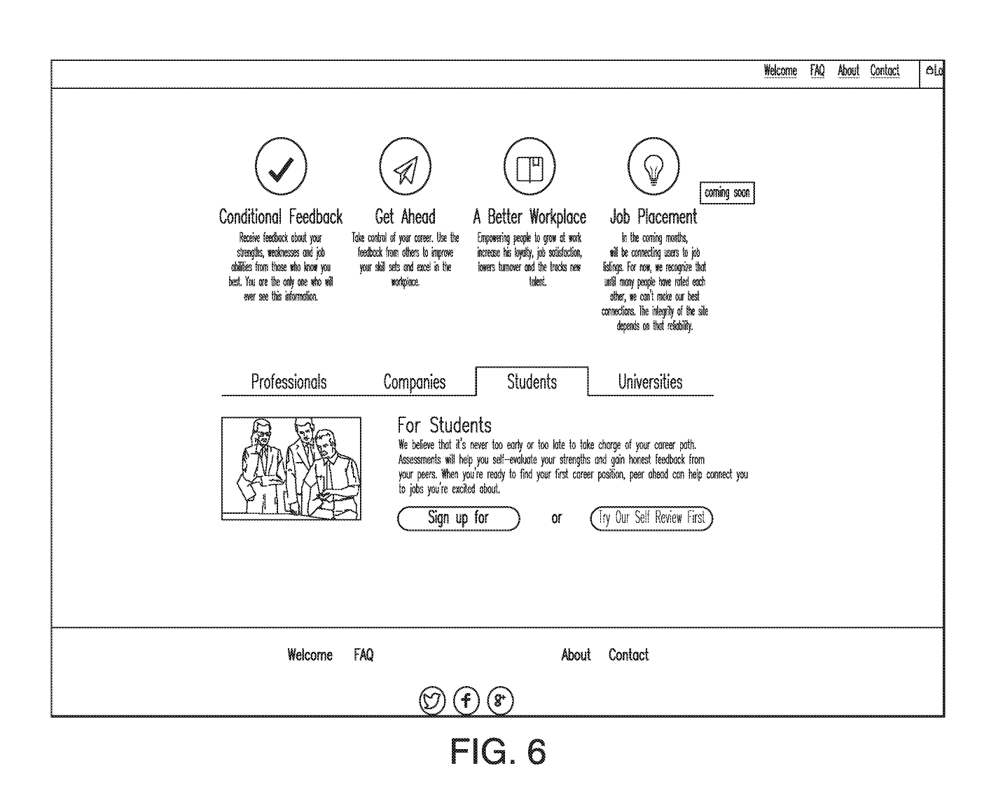

For example, FIG. 6 is a diagram that illustrates a view of a graphical user interface provided to professionals, students and companies according to an embodiment.

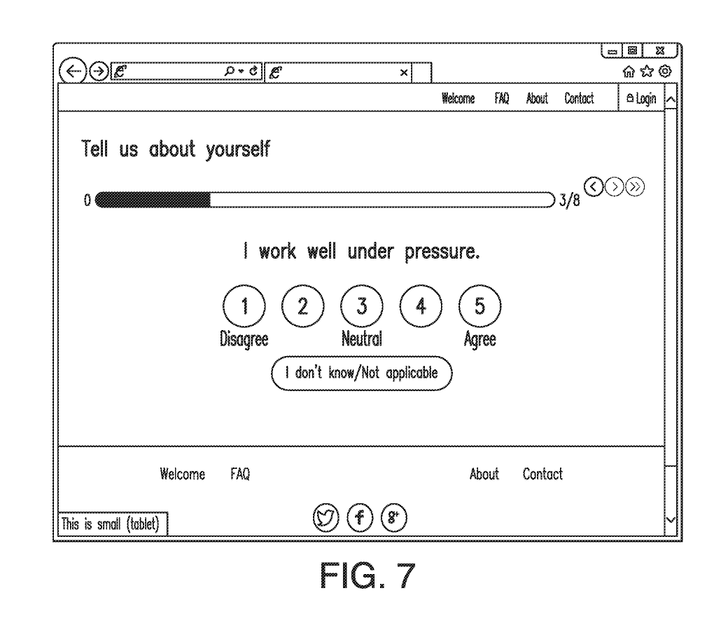

Also, in other examples, FIGS. 7-17 are diagrams that illustrate different views of the graphical user interface provided to professionals and students, according to an embodiment.

FIG. 7 is an example interface enabling the user to select how well she agrees with a statement pertaining to her personality. This may be used on her self-evaluation.

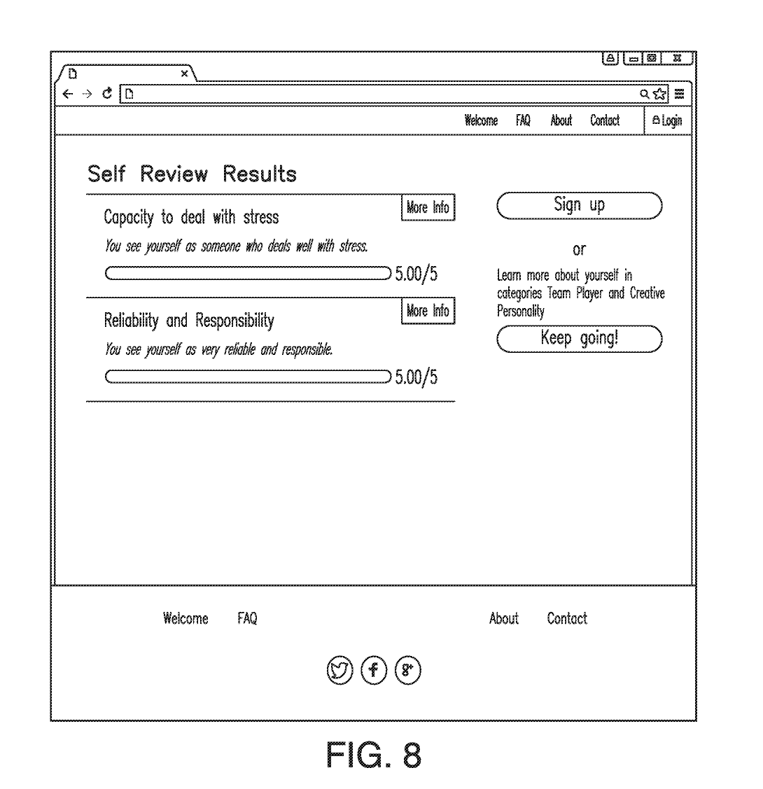

FIG. 8 is an example interface illustrating overall scores on several criteria in a user's self-evaluation.

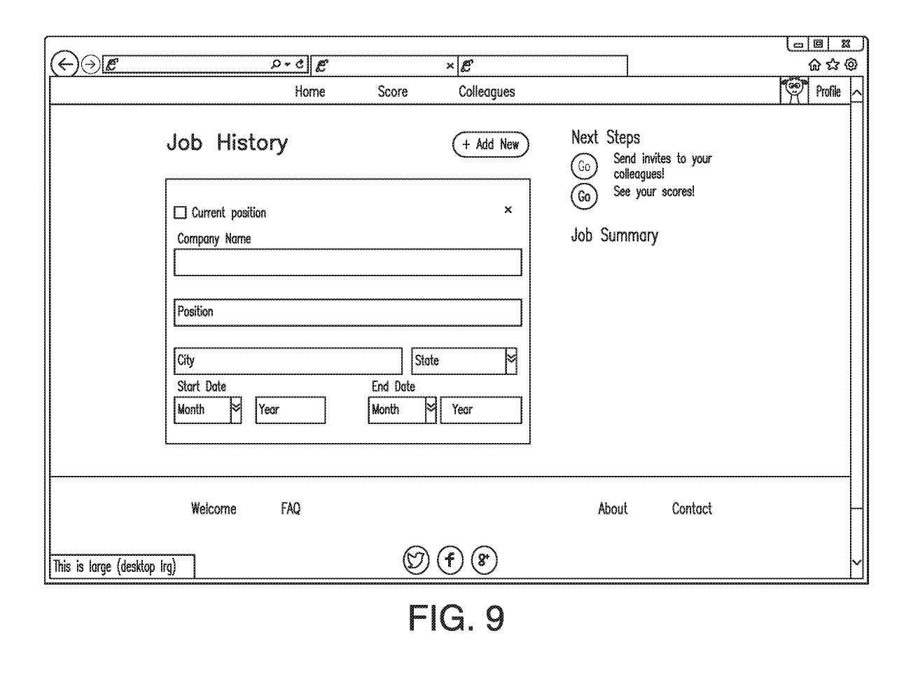

FIG. 9 is an interface enabling a user to enter in job history. The entered job history may be used to better match the user to potential employers and identify colleagues, among other functions.

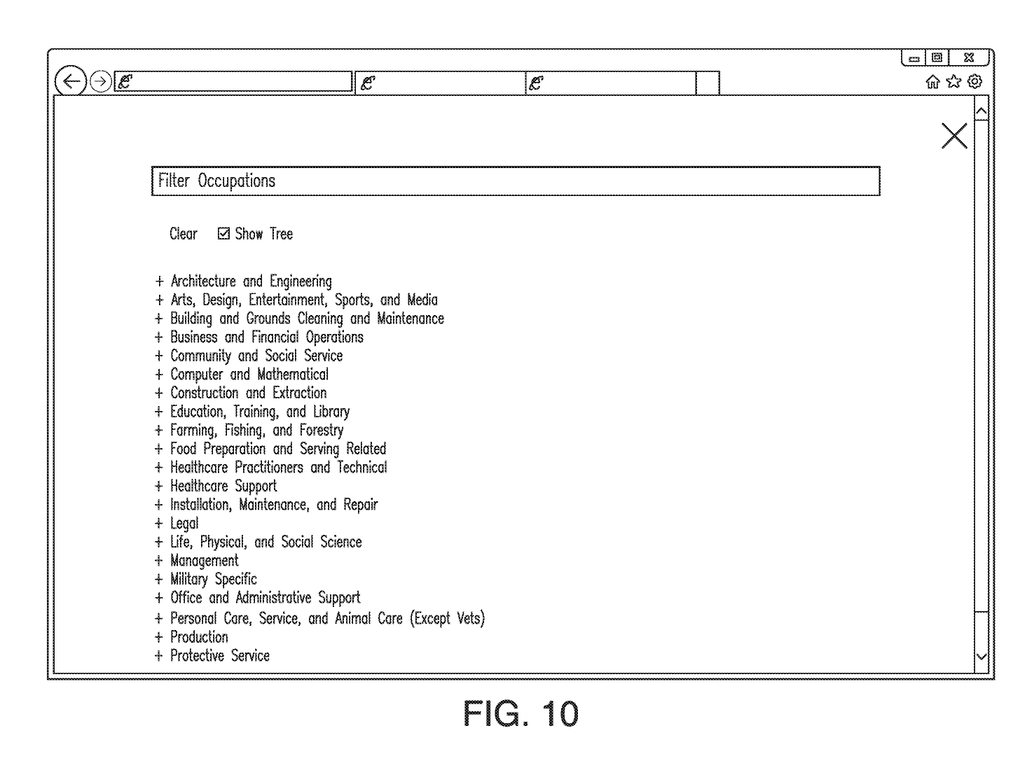

FIG. 10 is an interface enabling a user to select her occupation. The entered occupation may be used to better match the user to potential employers.

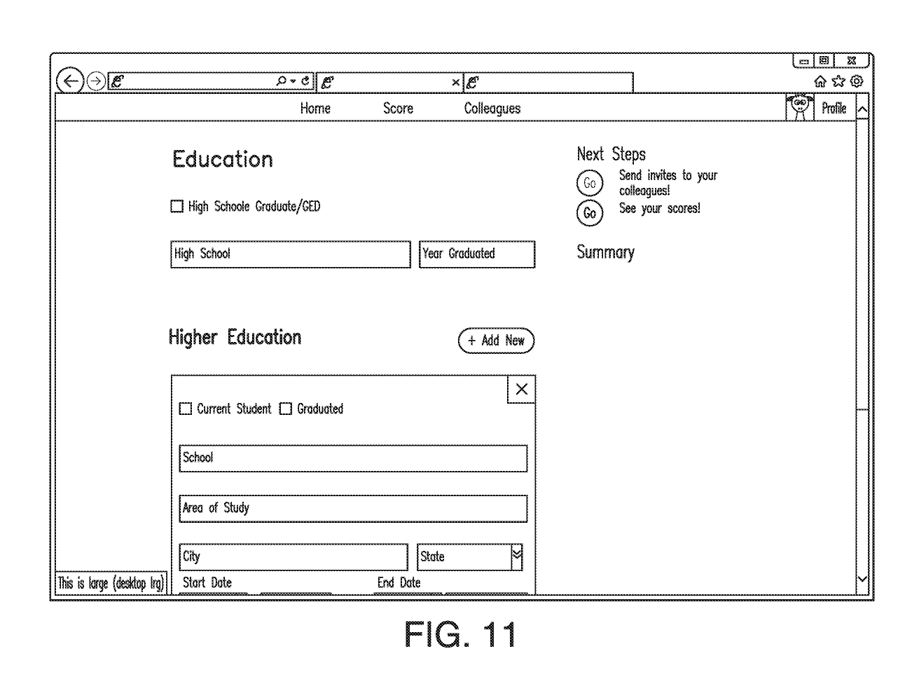

FIG. 11 is an interface enabling user to select her education. The entered education may be used to better match the user to potential employers.

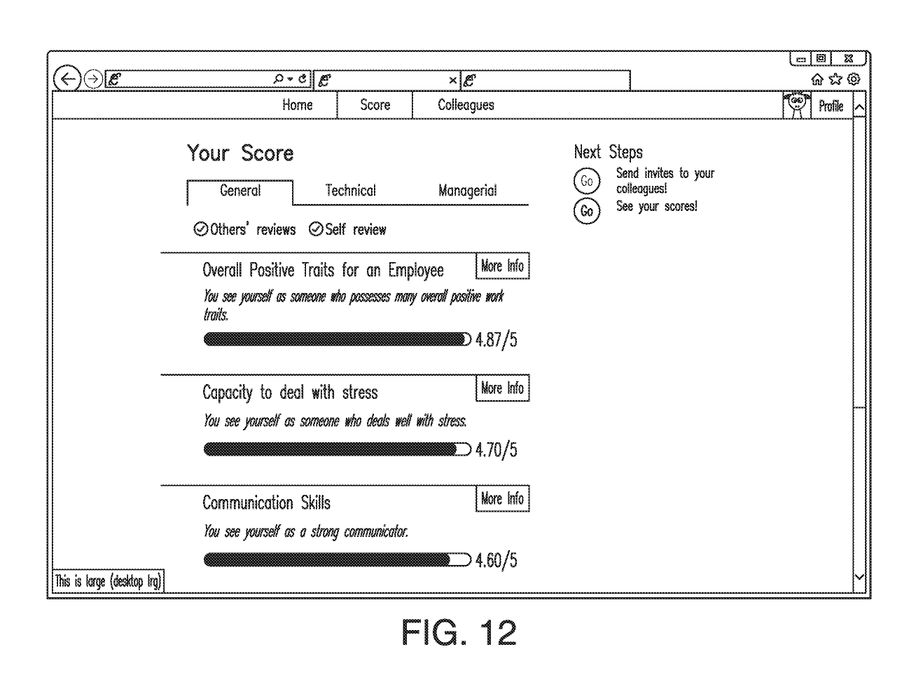

FIG. 12 is an interface illustrating a self-evaluation for several different areas. In addition, the scores presented in FIG. 12 may include the peer evaluation scores as well. FIG. 12 also has three tabs indicating three different areas of evaluation: general, technical, and managerial.

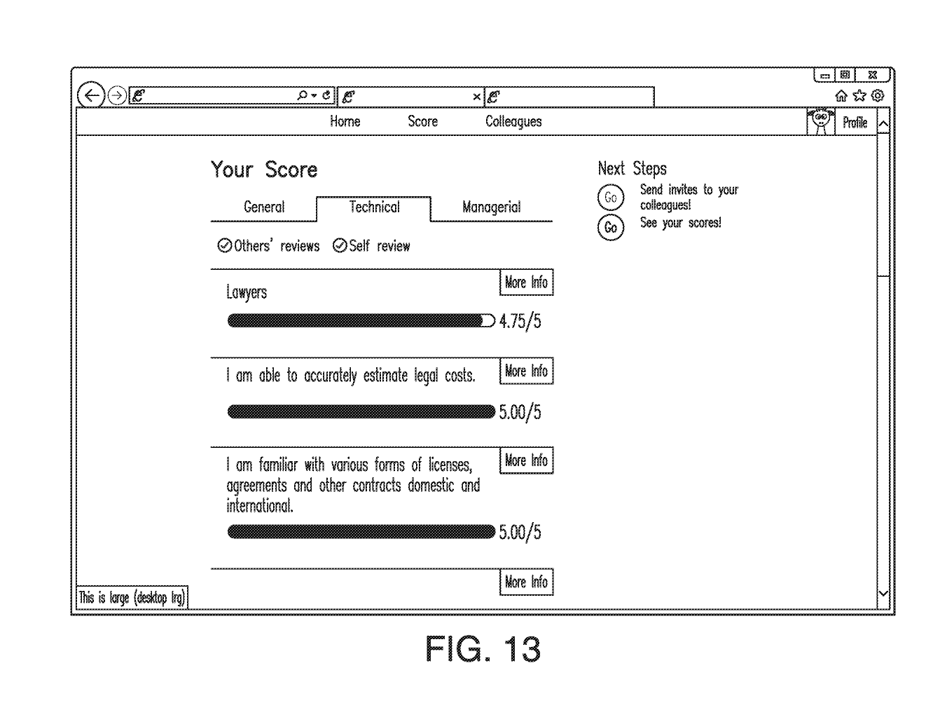

FIG. 13 shows the technical tab from FIG. 12.

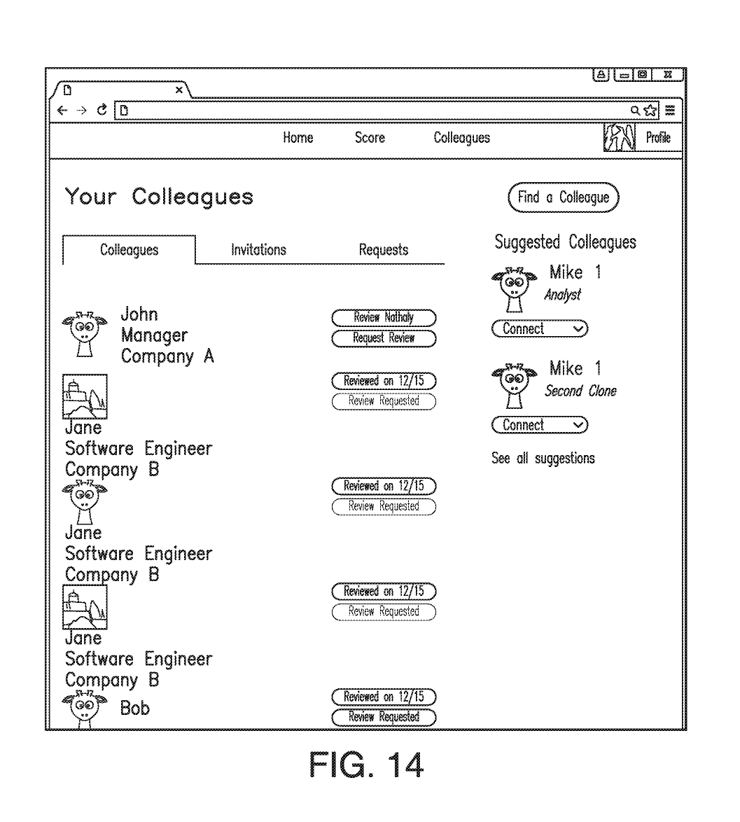

FIG. 14 lists colleagues and indicates whether the colleagues have submitted peer evaluations. In addition, the interface in FIG. 14 enables a user to request an evaluation from a colleague.

After the user requests an evaluation from a colleague (peer), the colleague may be presented with interface such as shown in FIG. 15. FIG. 15 is an interface enabling the colleague to specify her relationship with the user. For example, FIG. 15 specifies whether the user or colleague is a subordinate, and the degree of confidence the colleague has in her ability to rate the user in her non-technical and occupation related skills. The user requesting review is presented with a similar interface and is similarly asked to specify whether the evaluator is a colleague or a subordinate, and the degree of confidence the user has in the evaluator's ability to rate her on her non-technical and occupation related skills.

FIG. 16 shows the interface in FIG. 15 filled out.

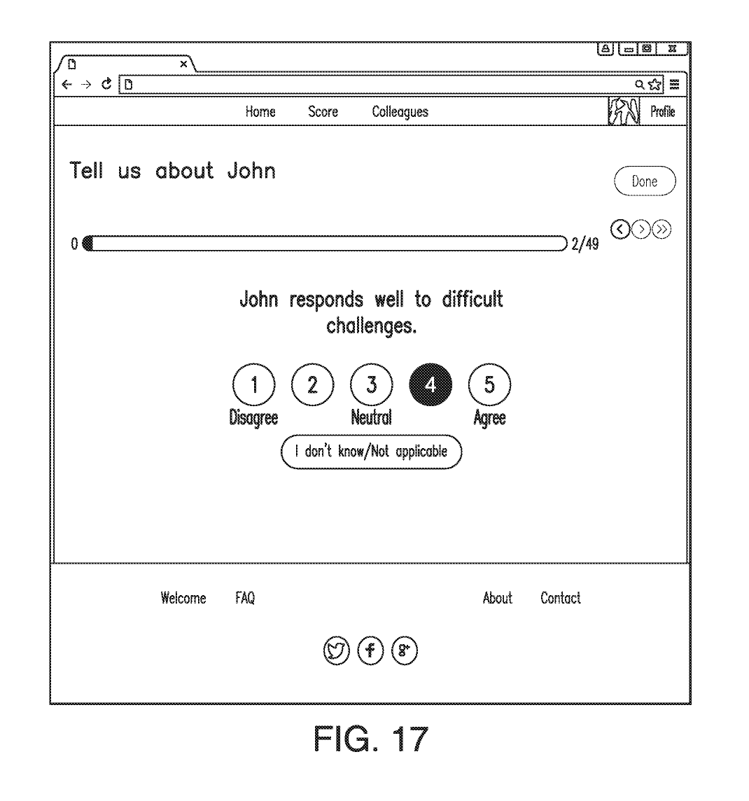

After the colleague specifies her relationship with the user in FIGS. 15 and 16, the colleague may fill out a peer evaluation. The colleague may fill out a peer evaluation by indicating her degrees agreements to a variety of statements as shown in the interface and FIG. 17.

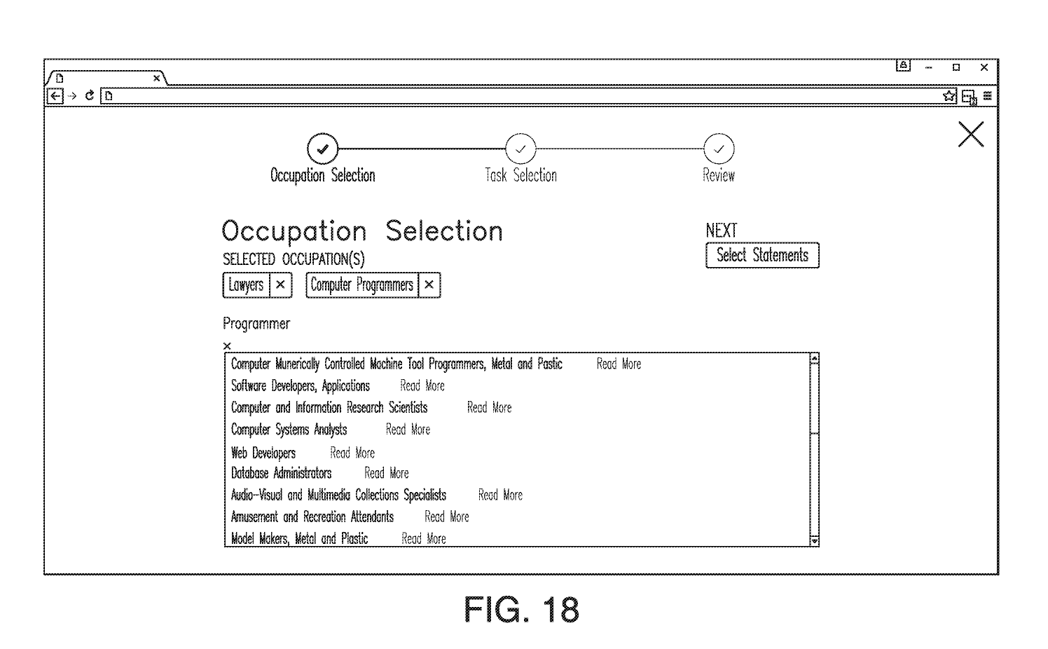

FIG. 18 is shows an interface for an embodiment wherein a professional may select more than one occupation. This interface provides a user with more specific occupation selections that those illustrated in FIG. 10. In an example, the interface provided in FIG. 18 is presented to the user after she uses the interface presented in FIG. 10 to select, under computer and mathematical, her occupation as programmer. In this example, using the interface provided in FIG. 18, the user can select her specific occupation as “Web Developer”. The entered occupation may be used to better match the user to potential employers.

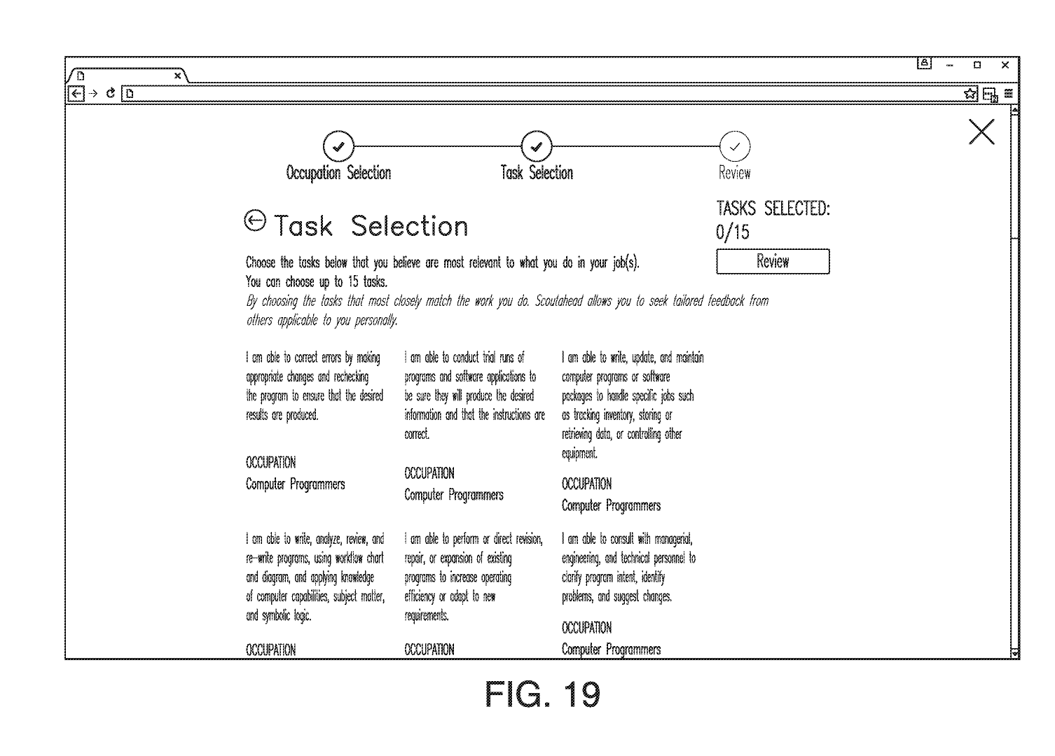

FIG. 19 shows an interface for an embodiment wherein a professional may select tasks specific to their duties within their occupation. In an example, this interface is presented to the user after she selects her specific occupation using the interface provided in FIG. 18.

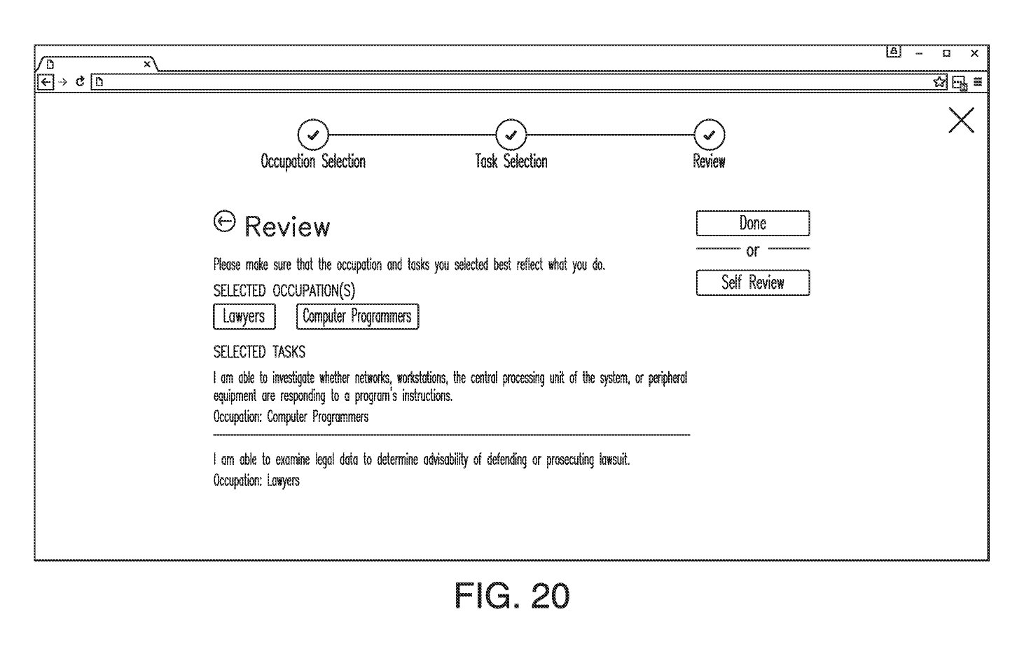

FIG. 20 shows an interface for an embodiment wherein a professional may review the occupation(s) and tasks specific to their duties within the occupation(s) they identified.

In an embodiment, user interface 510 may further comprise a display that provides both the results of self-evaluation and peer evaluation in one screen (e.g., side by side).

Returning to FIG. 5A, the evaluation/recommendation matching engine 102 further comprises an evaluation module 512 that is configured to receive and store statement ratings provided by peer evaluators, and aggregate them to provide overall statement ratings, and overall criterion scores, as previously described with respect to methods 200 and 400 in FIGS. 2 and 4A-4B respectively. The evaluation module 512 may also be configured to receive and store statement ratings provided by all or a subset of members of a peer group in evaluating the peer group, and aggregate them to provide overall statement ratings, and overall criterion scores for the peer group, as previously described with respect to method 480 in FIG. 4C. The evaluation module 512 may also be configured to receive and store self-evaluation-based statement ratings. Furthermore, the evaluation module 512 may be configured to identify a set of potential peer evaluators for a professional, and store a subset of those selected by the professional that have also been approved by the peer evaluators, as was previously described with respect to steps 210 and 212 of FIG. 2A. Additionally, evaluation module 512 may be further configured to identify one or more experts in a profession category who have high overall scores in criteria related to that profession category, and ask them to provide statements that they deem helpful in rating other professionals in that profession category. Additionally, evaluation module 512 is further configured to compute and store overall scores computed for a plurality of criteria related to the profession category of a professional, as was previously described with respect to step 214 of FIGS. 2, 4A and 4B. The evaluation module 512 is further configured to at least perform all the steps of methods 400 and 450.

The evaluation/recommendation matching engine 102 further comprises a recommendation module 514, that provides candidate recommendations to employers subscribed to the system that have indicated having open positions for which they are soliciting candidates. Recommendation module 514 is configured to perform operations described with respect to FIG. 3 (and method 300) that are required to be performed by the evaluation/recommendation matching engine. Additionally, recommendation module 514 is configured to perform operations related to steps 216-218 of method 200 that are required to be performed by the evaluation/recommendation matching engine, as previously described with respect to FIG. 2A. For example, recommendation module 514 is configured to receive and store indications from professionals that are interested in new positions, and compute match indices indicating the degree to which each of a plurality of professionals is a good candidate for an open position.

Employer database 502, skilled professional database 504, and statement database 506 may be any stored type of structured memory, including a persistent memory. In examples, this database may be implemented as a relational database or file system.

FIG. 5B is a diagram that illustrates a system for providing user evaluations in a common-interest group according to an embodiment.

Specifically, example components of the evaluation engine 152 are depicted in FIG. 5B, according to an embodiment. Evaluation engine 152 may include a user database 554, a statement database 558, an evaluation module 562, and a user interface 560. Each of these components are described in turn.

User database 554 can store information associated with all users, such as users 154 subscribed to evaluation engine 152. The stored information on user database 554 may include user pictures, user profiles, user interests, user's connections with other users, user's membership in one or more groups, user's personal statements, individual and overall ratings received from evaluators of a user on her/his personal statements and/or on questions directed to the user, scores of groups in which a user participates, permission information of the user, and any other information associated with a user that is solicited or computed as described with respect to FIGS. 1B, 2B and 4C.

In embodiments, evaluation engine 152 includes a statement database 558 that stores statements associated with different common-interest groups. Additionally or alternatively, statement database 558 may also store personal statements created by each user. In an embodiment, statement database 558 stores a list of suggested questions for evaluating a common-interest group, and/or suggested personal statements. Users interested in creating personal or group statements may use this bank of questions to select a subset of questions they see most fit.

Evaluation module 562 is configured to compute and store overall scores computed for a plurality of criteria related to the users of a common-interest group on statements associated with group criteria and/or member specific criteria, as was previously described with respect to FIG. 4C. The evaluation module 562 is further configured to at least perform all the steps of method 480. In an embodiment, evaluation module 562 is configured to compute and store overall scores computed for a user's personal statements based on the ratings provided by evaluators selected by the user.

Evaluation module 562 is further configured to perform operations related to steps 252-262 of method 250 that are required to be performed by the evaluation engine, as previously described with respect to FIG. 2B. For example, evaluation module 562 is configured to receive statement ratings from one or more evaluators as selected by a user. Furthermore, evaluation module 562 is configured to compute an aggregated and/or anonymized overall rating for each statement in the list of personalized statements, based on the provided ratings, as described previously with respect to steps 260 and 262.

User interface 560 facilitates receiving inputs from, and providing outputs to the users of the system. In an embodiment, the user interface is a web-based graphical user interface, and can be accessed via any of the common web browsers, such as Internet Explorer, Firefox, Safari, Chrome, etc. In another embodiment, the user interface is a software application that runs on a device such as a laptop, a smart phone or a tablet.

User interface 560 may provide different views to its different customers. For example, user interface 560 may provide a first view for a user's professional network, and a second view for the user's social network. Additionally, in viewing a common-interest group created by a moderator, the moderator may see a different view than other members.

### CONCLUSION

Each of the processors and modules in FIGS. 1, 5A and 5B, including evaluation module 512, recommendation module 514, and evaluation module 562, may be implemented in hardware, software, firmware, or any combination thereof.

Each of the processors and modules in FIGS. 5A and 5B may be implemented on the same or different computing devices. Such computing devices can include, but are not limited to, a personal computer, a mobile device such as a mobile phone, workstation, embedded system, game console, television, set-top box, or any other computing device. Further, a computing device can include, but is not limited to, a device having a processor and memory, including a non-transitory memory, for executing and storing instructions. The memory may tangibly embody the data and program instructions. Software may include one or more applications and an operating system. Hardware can include, but is not limited to, a processor, a memory, and a graphical user interface display. The computing device may also have multiple processors and multiple shared or separate memory components. For example, the computing device may be a part of or the entirety of a clustered or distributed computing environment or server farm.

Identifiers, such as “(a),” “(b)”, “(i)”, “(ii)”, etc., are sometimes used for different elements or steps. These identifiers are used for clarity and do not necessarily designate an order for the elements or steps.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for matching a candidate with a position, comprising:
(a) receiving a plurality of criteria specifying an employer's requirements for the position;
for each candidate in a plurality of candidates:
(b) receiving a plurality of ratings entered by a plurality of peers of the candidate, each rating indicating a degree to which the corresponding peer agrees with a statement pertaining to the candidate's skills or abilities for respective criterion in the plurality of criteria;
(c) for each of the plurality of ratings, determining a weight indicating a confidence in the rating;
(d) for respective criterion in the plurality of criteria, aggregating the plurality of ratings based on the respective weights to generate an overall score for the respective criterion;
(e) determining, based on the candidate's overall scores for the respective criterion in the plurality of criteria, a match index indicating a likelihood that the candidate is a fit for the position; and
(f) based on the match indices determined in (e), matching a candidate for the position.

2. The method of claim 1, wherein the determining (c) comprises determining the weight based on an overall score for the criterion for a peer that entered the rating.

3. The method of claim 2, further comprising:
(g) for each of the plurality of candidates, repeating (b)-(e) until the overall scores converge.

4. The method of claim 3, wherein the repeating (g) comprises:
(i) determining a Euclidean distance between a first vector including scores determined during a current iteration and a second vector including scores determined during a previous iteration;
(ii) determining whether the Euclidean distance is below a threshold; and
(iii) when the Euclidean distance is determined to be below the threshold, determining that the respective scores have converged.

5. The method of claim 1, wherein the determining (c) comprises determining the weight based on a degree to which a peer that entered the rating knows the candidate.

6. The method of claim 5, wherein the determining (c) comprises determining the degree to which the peer that entered the rating knows the candidate based on a first input from the peer that entered the rating and a second input from the candidate, such that the degree is discounted based on a discrepancy between the first and second input.

7. The method of claim 1, further comprising:
(g) recommending the matched candidate to the employer for the position.

8. The method of claim 1, further comprising:
(g) recommending the position to the matched candidate.

9. The method of claim 1, further comprising:
(g) for respective criterion in the plurality of criteria, receiving an importance value indicating an importance of the criteria to the position,
wherein the determining (e) comprises determining the match index based on the importance values for the respective criterion in the plurality of criteria.

10. The method of claim 1, further comprising, for a candidate in the plurality of candidates:
(g) determining whether a number of the plurality of peers that entered the plurality of ratings exceeds a threshold;
(h) only if the number is determined to exceed the threshold, presenting the overall score generated in (d) to the candidate.

11. The method of claim 1, wherein the candidate is an employee of the employer.

12. A program storage device tangibly embodying a program of instructions executable by at least one machine to perform a method for matching a candidate with a position, comprising:
(a) receiving a plurality of criteria specifying an employer's requirements for the position;
for each candidate in a plurality of candidates:
(b) receiving a plurality of ratings entered by a plurality of peers of the candidate in the plurality of candidates, each rating indicating a degree to which the peer agrees with a statement pertaining to the candidate's skills or abilities for respective criterion in the plurality of criteria;
(c) for each of the plurality of ratings, determining a weight indicating a confidence in the rating;
(d) for respective criterion in the plurality of criteria, aggregating the plurality of ratings based on the respective weights to generate an overall score for the respective criterion;
(e) determining, based on the candidate's overall scores for the respective criterion in the plurality of criteria, a match index indicating a likelihood that the candidate is a fit for the position; and
(f) based on the match indices determined in (e), matching a candidate for the position.

13. The program storage device of claim 12, wherein the determining (c) comprises determining the weight based on an overall score for the criterion for a peer that entered the rating.

14. The program storage device of claim 13, the method further comprising:
(g) for each of the plurality of candidates, repeating (b)-(e) until the overall scores converge.

15. The program storage device of claim 14, wherein the repeating (g) comprises:
(i) determining a Euclidean distance between a first vector including scores determined during a current iteration and a second vector including scores determined during a previous iteration;
(ii) determining whether the Euclidean distance is below a threshold; and
(iii) when the Euclidean distance is determined to be below the threshold, determining that the respective scores have converged.

16. The program storage device of claim 12, wherein the determining (c) comprises determining the weight based on a degree to which a peer that entered the rating knows the candidate.

17. The program storage device of claim 16, wherein the determining (c) comprises determining the degree to which the peer that entered the rating knows the candidate based on a first input from the peer that entered the rating and a second input from the candidate, such that the degree is discounted based on a discrepancy between the first and second input.

18. The program storage device of claim 12, the method further comprising:
(g) recommending the matched candidate to the employer for the position.

19. The program storage device of claim 12, the method further comprising:
(g) recommending the position to the matched candidate.

20. The program storage device of claim 12, the method further comprising:
(g) for respective criterion in the plurality of criteria, receiving an importance value indicating an importance of the criteria to the position,
wherein the determining (e) comprises determining the match index based on the importance values for the respective criterion in the plurality of criteria.

21. The program storage device of claim 12, the method further comprising, for a candidate in the plurality of candidates:
(g) determining whether a number of the plurality of peers that entered the plurality of ratings exceeds a threshold;
(f) only if the number is determined to exceed the threshold, presenting the overall score generated in (d) to the candidate.

22. The program storage device of claim 12, wherein the candidate is an employee of the employer.

23. A system for matching a candidate with a position, comprising:
a user interface module that receives a plurality of criteria specifying an employer's requirements for the position;
an evaluation module that, for each candidate in a plurality of candidates:
(i) receives a plurality of ratings entered by a plurality of peers of the candidate, each rating indicating a degree to which the corresponding peer agrees with a statement pertaining to the candidate's skills or abilities for respective criterion in the plurality of criteria,
(ii) for each of the plurality of ratings, determines a weight indicating a confidence in the rating,
(iii) for respective criterion in the plurality of criteria, aggregates the plurality of ratings based on the respective weights to generate an overall score for the respective criterion,
(iv) determines, based on the candidate's overall scores for the respective criterion in the plurality of criteria, a match index indicating a likelihood that the candidate is a fit for the position; and
a recommendation module that, based on the match indices determined by the evaluation module, matches a candidate for the position.
